(19) United States
(12) Patent Application Publication
(10) Pub. No.: US 2002/0141685 A1
(43) Pub. Date: Oct. 3, 2002

(54) Optical switch having a reduced cross talk

(76) Inventor: Chi Wu, San Marino, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/076,600

(22) Filed: Feb. 15, 2002

Related U.S. Application Data
(63) Continuation-in-part of application No. 09/686,733, filed on Oct. 10, 2000.
(60) Provisional application No. 60/269,210, filed on Feb. 15, 2001.

(51) Int. Cl. G02B 6/35

(52) U.S. Cl. 385/16; 385/17

(57) ABSTRACT

The invention relates to an optical switch. The optical switch includes a light barrier having a surface between sides. The switch also includes a first light transmitting medium having one or more ridges. Each ridge defines a portion of an input waveguide. The light transmitting medium is positioned such that at least one of the ridges is positioned over the surface of the light barrier. A second light transmitting medium is positioned adjacent to the sides of the light barrier.

### RELATED APPLICATIONS

This application is a continuation-in-part of U.S. patent application Ser. No. 09/686,733, filed on Oct. 10, 2000, entitled “Waveguide Having a Light Drain” and incorporated herein in its entirety and claims the benefit of U.S. Provisional Patent Application serial No. 60/269,210, filed on Feb. 15, 2001, entitled “Method and Apparatus for Reducing Cross Talk in an Optical Switch” and incorporated herein in its entirety.

This application is related to U.S. patent application Ser. No. 09/723,764, filed on Nov. 28, 2000, entitled “Silica Waveguide” and incorporated herein in its entirety and which claims the benefit of U.S. Provisional Patent Application serial No. 60/239,534, filed on Oct. 10, 2000, entitled “A Compact Integrated Optics Based Arrayed Waveguide Demultiplexer” and incorporated herein in its entirety.

### BACKGROUND

1. Field of the Invention

The invention relates in general to one or more optical networking components and, more particularly, to optical switches.

2. Background of the Invention

Optical switches are used in a variety of optical equipment, devices and systems. Optical switches allow a light signal to be directed to one of a plurality of output waveguides. An example of a typical optical switch has a single input waveguide and two output waveguides. The optical switch directs the received light signal form the input waveguide to either one of the two output waveguides in response to a control signal.

One type of optical switch includes a light transmitting medium positioned adjacent to a base. The waveguides are typically defined in the light transmitting medium such as silicon. Light signals in a waveguide often escape from the waveguide. These light signals can become trapped in the light transmitting medium and can enter other waveguides defined in the light transmitting medium. As a result, the escaped light signals are a source of cross talk that degrades performance of the switch.

For the above reasons there is a need for an optical switch with reduced cross talk.

### SUMMARY OF THE INVENTION

The invention relates to an optical switch. The optical switch includes a light barrier having a surface between sides. The switch also includes a first light transmitting medium having one or more ridges. Each ridge defines a portion of an input waveguide. The light transmitting medium is positioned such that at least one of the ridges is positioned over the surface of the light barrier. A second light transmitting medium is positioned adjacent to the sides of the light barrier.

Another embodiment of the switch includes a light barrier having a surface between sides. The switch also includes a first light transmitting medium having one or more ridges. Each ridge defines a portion of an output waveguide. The light transmitting medium is positioned such that at least one of the ridges is positioned over the surface of the light barrier. A second light transmitting medium is positioned adjacent to the sides of the light barrier.

In some instances, the second light transmitting medium has an index of refraction equal to or greater than an index of refraction of the first light transmitting medium. The first light transmitting medium and the second light transmitting medium are the same material. In one instance, the first light transmitting medium and the second light transmitting medium are silicon.

In some instances, a first doped region is positioned in the ridge and a second doped region is positioned adjacent to the ridge. A second doped region can be positioned adjacent to a side of the ridge and/or under the ridge. A second electrical contact can be positioned over the second doped region.

In some instances, a width of the light barrier is less than 150% of a width at a base of the ridge. In other instances, the width of the light barrier is less than 140% of the width at a base of the ridge, less than 130% of a width at a base of the ridge or less than 120% of a width at a base of the ridge.

Another embodiment of the optical switch includes a plurality of output waveguides in optical communication with one or more input waveguides. A modulator is configured to modulate light signals being carried by a first output waveguide. The first output waveguide is one of the plurality of output waveguides.

Another embodiment of the optical switch includes a switching element configured to direct light signals to at least one of a plurality of output waveguides. A modulator is configured to modulated light signals carried by at least one first output waveguide. The first output waveguide being one of the plurality of output waveguides.

Still another embodiment of the optical switch includes a plurality of output waveguides in optical communication with an input waveguide. One of the output waveguides is configured so as to shift a light signal from the input waveguide toward a center of another output waveguide before the light signal enters the other output waveguide.

Another embodiment of the optical switch includes a plurality of active output waveguides. A switching element configured to direct a light signal to an active output waveguide selected from among the plurality of active output waveguides. One or more secondary output waveguides are configured to receive a portion of the light signal when the light signal is directed toward an active output waveguide.

Yet another embodiment of the optical switch includes a plurality of active output waveguides in optical communication with an input waveguide and one or more secondary output waveguides in optical communication with the input waveguide. A switching element is configured to direct light signals to an output waveguide that is selectable from among only the active output waveguides.

Still another embodiment of the switch includes a first output waveguide in optical communication with an input waveguide and a second output waveguide in optical communication with the input waveguide. A switching member is configured to direct light signals to the first output waveguide or the second output waveguide. The switch also includes a third output waveguide in optical communication with the input waveguide. The third output waveguide is configured to receive a portion of each light signal directed to the second output waveguide.

Another embodiment of the switch includes a plurality of output waveguides that share a region of the switch. The shared region of the switch includes an expanded region shaped so as to center light signals relative to one of the output waveguides before entering the output waveguide.

The invention also relates to an optical switching architecture. The optical switching architecture includes a plurality of optical switches. Each optical switch has a plurality of output waveguides. A common waveguide is in optical communication with a first output waveguide from each of the optical switches. The switching architecture also includes a plurality of modulators. Each modulator is configured to modulate the light signals carried by one of the first output waveguides.

The invention also relates to a method for operating a switch. The method includes directing light signals toward at least one of a plurality of output waveguides. The method also includes modulating light signals carried on a first output waveguide. The first output waveguide is one of the plurality of output waveguides.

The invention also relates to a method of operating a switching architecture. The method includes converting light signals carried on a common waveguide to electrical signals. The common waveguide receives the light signals from a plurality of optical switches. The method also includes separating a modulated portion of the electrical signals from the remainder of the electrical signals. The modulated portion of the electrical signals resulting from the light signals from one or more of the optical switches being modulated before entering the common waveguide.

### BRIEF DESCRIPTION OF THE FIGURES

FIG. 1 illustrates a switching system including a switch in communication with a controller.

FIG. 2 is a schematic of a plurality of switches arranged in a switching architecture.

FIG. 3 illustrates a modulation scheme employing a signal generator and a phase locked loop.

FIG. 4 illustrates a modulation scheme employing a modulator configured to encode light signals and a decoder configured to decode the light signals.

FIG. 5 illustrates a modulation scheme employing a filter for filtering out signals within range of frequencies.

FIG. 6A through FIG. 6E illustrate a variety of optical switch configurations according to the present invention.

FIG. 7A illustrates construction of an optical component including a switching architecture employing a plurality of switches. The component includes a light transmitting medium positioned over a base.

FIG. 7B is a cross sectional view of the optical component illustrated in FIG. 7A.

FIG. 8A and FIG. 8B illustrate different base constructions that can be used in conjunction with the component construction shown in FIG. 7A.

FIG. 9A through FIG. 9C illustrate an embodiment of a modulator that is suitable for use with an optical component including a switch.

FIG. 10A through FIG. 10F illustrate embodiments of a switching element suitable for use with an optical component including a switch. The switching element is configured to direct a light signal to one of a plurality of output waveguides.

FIG. 11 illustrates a reflector that is suitable for use with an optical component including a switch. The reflector is configured to reflect light signals from one waveguide into another waveguide.

FIG. 12A through FIG. 12C illustrate a junction of waveguides of an optical switch. A side of one waveguide expands away from the other side of the waveguide in order to provide an expanded region. The expanded region can extend into another waveguide and is configured to reduce cross talk.

FIG. 13A through FIG. 13E illustrate an optical switch having three output waveguides. The third output waveguide is configured to reduce cross talk.

FIG. 14A through FIG. 14E illustrate a method of forming a component having an optical switch.

### DETAILED DESCRIPTION OF THE PREFERRED EMBODIMENT

The invention relates to an optical switch. The switch includes a light barrier having a surface between sides. The switch also includes a first light transmitting medium having one or more ridges. Each ridge defines a portion of a waveguide. The light transmitting medium is positioned such that the ridges are positioned over the surface of the light barrier. A second light transmitting medium is positioned adjacent to the sides of the light barrier.

Light signals that escape from the waveguides can pass from the first light transmitting medium into the second light transmitting medium. Because the second light transmitting medium is positioned adjacent to the sides of the light barrier, the escaped light signals can pass the sides of the light barrier. Light signals that pass the sides of the light barrier are not trapped in the first light transmitting medium and can not readily enter other waveguides. As a result, the light signals that escape from the waveguides are not a source of cross talk.

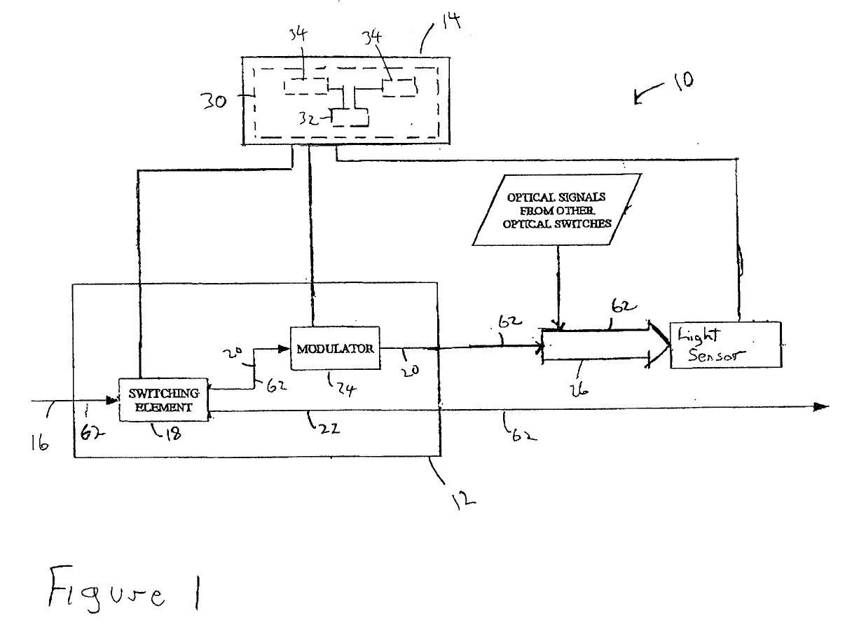

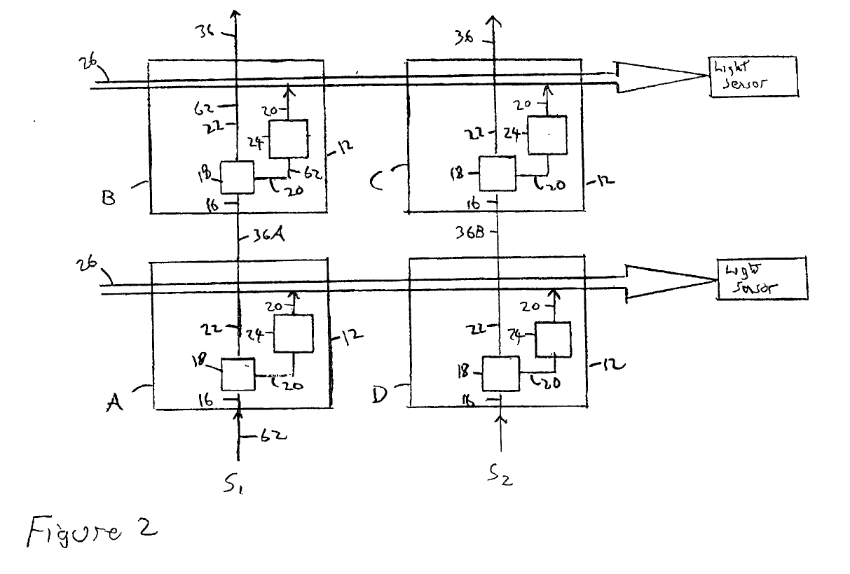

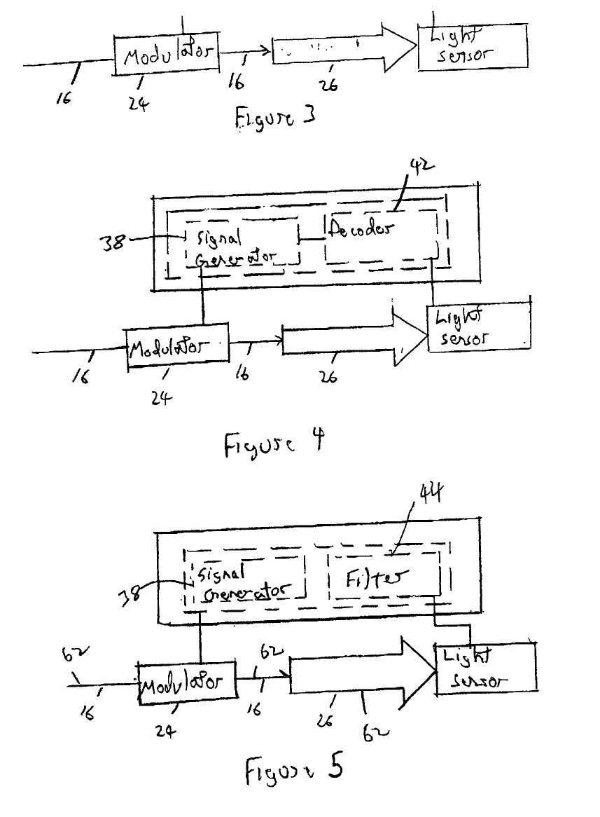

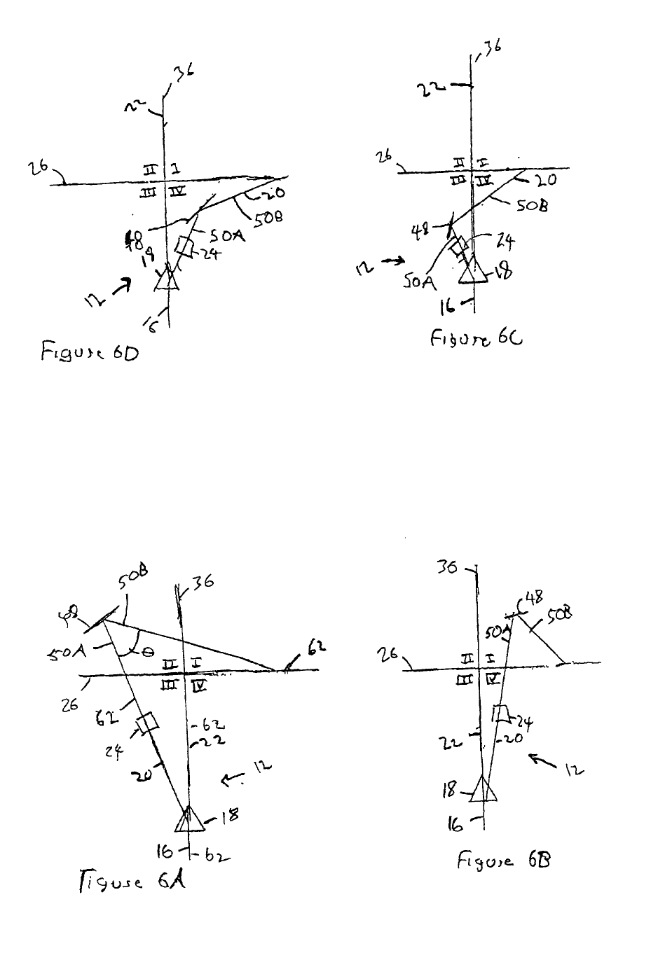

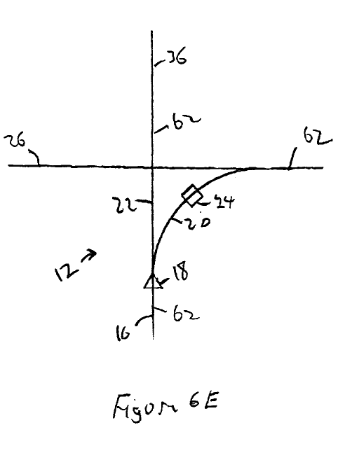

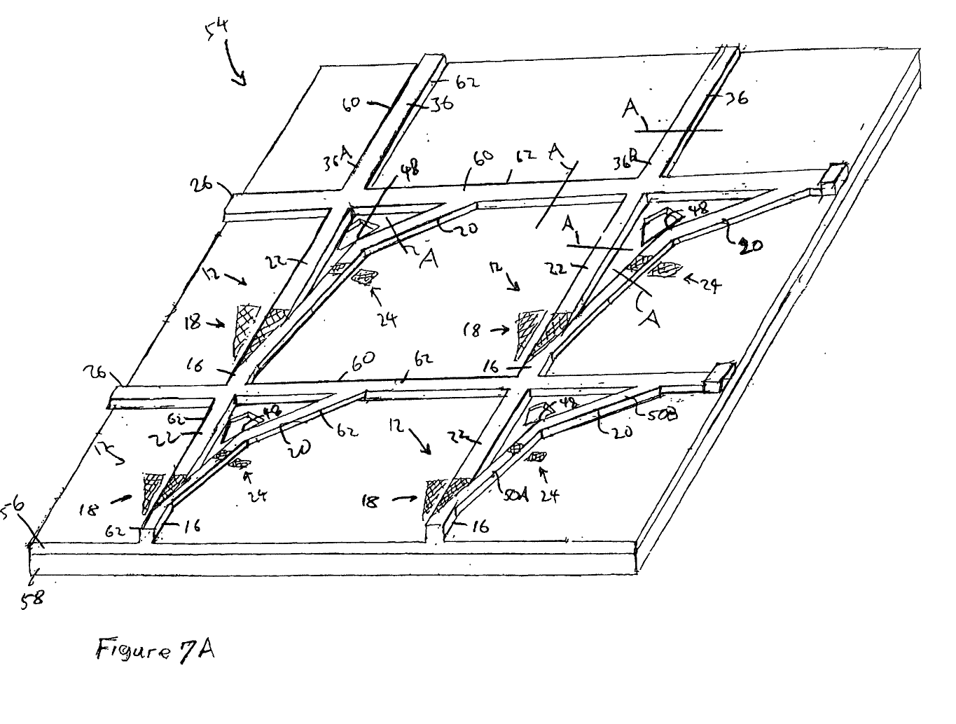

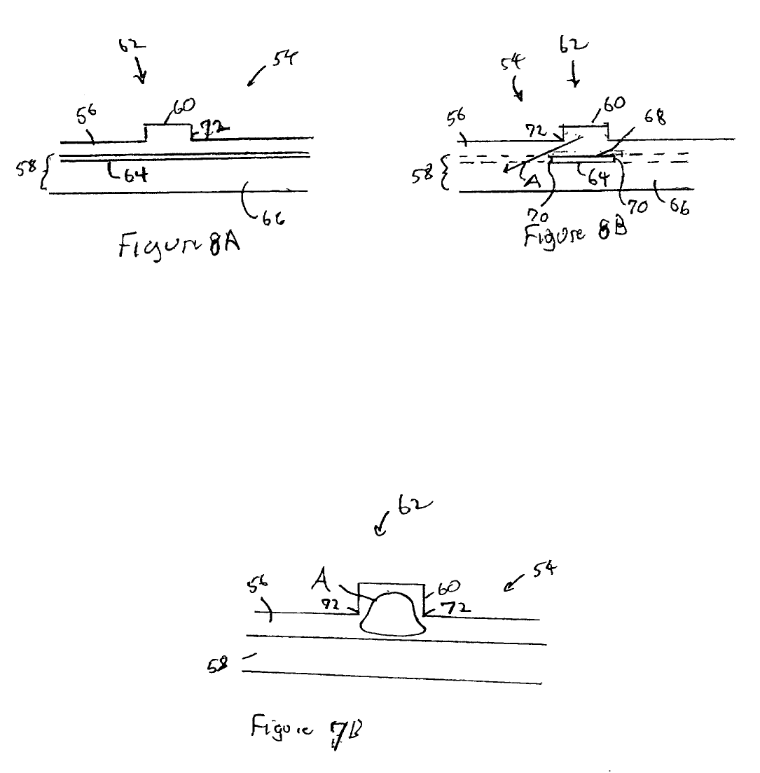

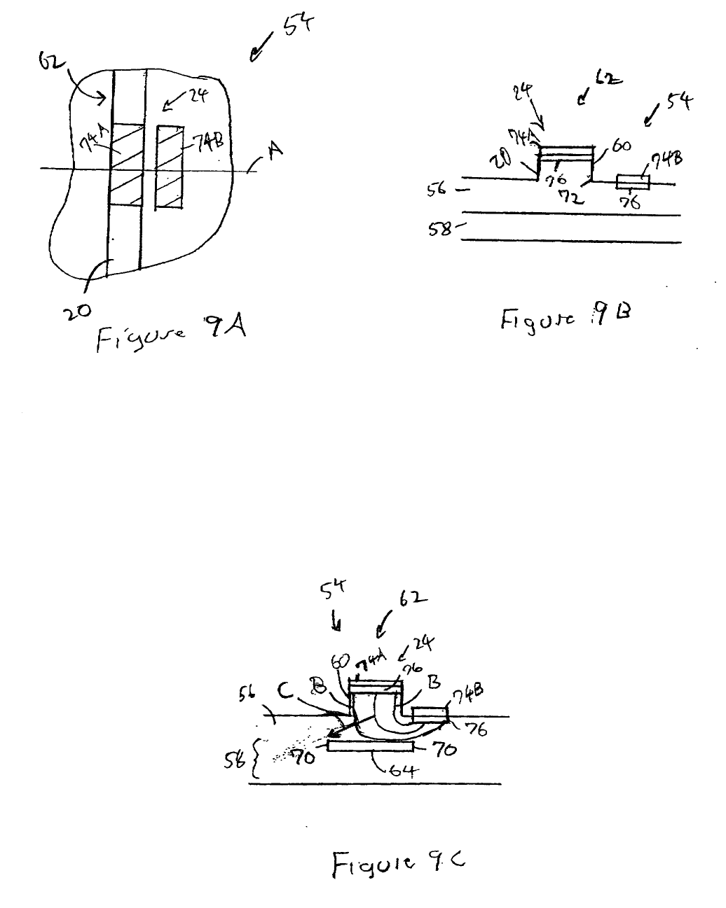

FIG. 1 is a block diagram of a switching system 10. The switching system 10 includes a switch 12 and a controller 14. The switch 12 includes an input waveguide 16 configured to carry light signals to a switching element 18. The switching element 18 is configured to direct light signals to a first output waveguide 20 or a second output waveguide 22. Although the switch 12 illustrated in FIG. 1 has a first output waveguide 20 and a second output waveguide 22, the concepts discussed herein can be applied to a switch 12 having more than two output waveguides and/or more than one input waveguide 16. Also, the various functional blocks illustrated in FIG. 1 may be implemented using a variety of techniques and components. Examples of some of the suitable implementations of the blocks are discussed below.

A modulator 24 is positioned along the first output waveguide 20 and is configured to modulate the light signals carried on the first output waveguide 20. The modulator 24 can provide amplitude based modulation of the light signals, frequency based modulation or phase based modulation. Suitable components for use as a modulator 24 include, but are not limited to, a Mach-Zehnder type modulator and an electro-absorption type modulator.

Light signals from the first output waveguide 20 are received on a common waveguide 26. In some instances, the common waveguide 26 is carrying light signals from other optical switches and in other instances; the common waveguide 26 is not carrying any other light signals. A light sensor 28 receives the light signals on the common waveguide 26. The light sensor 28 converts the light signals to electrical signals. A suitable light sensor 28 includes, but is not limited to, one or more photodetectors, one or more photodiodes, and one or more avalanche photodiodes, charge coupled devices (CCDs), and photomultiplier tubes.

The controller 14 is in communication with the switching element 18, the modulator 24 and the light sensor 28. The controller 14 can include electronics 30 for controlling various functions of the switch. For instance, the controller 14 can include electronics 30 for operating the switching element so as to direct light signals toward the first output waveguide 20 or the second output waveguide 22; operating the modulator 24 so as to modulate light signals on the first output waveguide 20 and/or electronics for processing the output of the light sensor 28.

The electronics 30 can include one or more processors 32. Suitable processors 32 include, but are not limited to, programmed general purpose digital computers, microprocessors, digital signal processors (DSP), integrated circuits, application specific integrated circuits (ASICs), logic gate arrays and switching arrays.

The electronics 30 can include one or more machine readable media 34 for storing instructions to be executed by the processor and/or for storing information to be used by the processor while executing instructions. Suitable machine readable media 34 include, but are not limited to, RAM, disk drives, optical discs such as a compact disk (CD), CD-ROM, CD-R (a recordable CD-ROM that can be read on a CD-ROM drive), CD-RW (multiple-write CD), CD-E (recordable and erasable CD), or DVD (digital video disc). Alternatively, instead of, or in addition to an optical disc, the machine readable media 34 can include one or more of the following: a magnetic data storage diskette (floppy disk), a Zip disk, DASD storage (e.g., a conventional “hard drive” or a RAID array), magnetic tape, RAM, electronic read-only memory (e.g., ROM, EPROM, or EEPROM), paper punch cards, or transmission media such as digital and/or analog communication links.

When the switching element 18 directs a light signal toward the second output waveguide 22, a portion of the light signal often leaks into the first output waveguide 20. The portion of the light signal that leaks into the first output waveguide 20 is referred to cross talk. When the switching element 18 directs a light signal toward the first output waveguide 20, the portion of the light signal that enters the first output waveguide 20 is referred to as the primary signal. While some cross talk does result from a portion of the light signal entering the second output waveguide 22, this source of cross talk is negligible for the purposes of the following discussion.

The cross talk that occurs when the switching element 18 directs the light signal toward the second output waveguide 22 can substantially affect the performance of the switch 12 because the first output waveguide 20 carries this cross talk to the common waveguide 26 where the cross talk can be combined with the light signals from other switches.

A plurality of switches can be arranged in a switching architecture as shown in FIG. 2. The first output waveguide 20 of a portion of the switches are in optical communication with a first common waveguide 26A and the first output waveguide 20 of another portion of the switches are in optical communication with a second common waveguide 26B.

The switching architecture includes a plurality of throughput waveguides 36. The input waveguide and the second output waveguide 22 of a portion of the switches are connected so as to form a first throughput waveguide 36A and the input waveguide and the second output waveguide 22 of another portion of the switches are connected so as to form a second throughput waveguide 36B. Although a total of four switches are illustrated, the switching architecture can be expanded to include many tens, hundreds, thousands and even millions of switches. Additionally, the switching architecture can be expanded to include many more than two throughput waveguides 36 and many more than two common waveguides 26.

Although the controller 14 is not illustrated, the controller 14 is in communication with the switching element 18 and the modulator 24 of each switch. Additionally, the controller 14 is in communication with each of the light sensors 28. The controller 14 controls the configuration of the switch. For instance, the controller 14 controls which common waveguide 26 carries the light signals from a particular throughput waveguide 36. The light signals carried on the first throughput waveguide 36A are labeled S1 while the light signals carried on the second throughput waveguide 36B are labeled S2, S1 can refer to a single wavelength of light or a single channel. However, the input waveguide 16 often carry many different wavelengths of light or many different channels. As a result, S1 and/or S2 can also refer to light signals at a collection of wavelengths or to a collection of channels.

The controller 14 can configure the switching architecture such that a common waveguide 26 carries the primary signals from more than one throughput waveguide 36. For instance, the controller 14 can configure the switching architecture such that the light signals labeled S1 and the light signal labeled S2 appear on the first common waveguide 26A. The light signals labeled S1 can be made to appear on the first common waveguide 26A by controlling the switch 12 labeled A such that the light signals labeled S1 are directed toward the first output waveguide 20. The first output waveguide 20 carries these light signals to the first common waveguide 26A. The light signals labeled S2 can be made to appear on the first common waveguide 26A by controlling the switch 12 labeled D such that the light signals labeled S2 are directed toward the first output waveguide 20. The first output waveguide 20 carries these light signals to the second common waveguide 26B. The first common waveguide 26A will be carrying two primary light signals, S1 and S2. Accordingly, a common waveguide 26 can carry more than one primary light signal.

Switches positioned along a throughput waveguide 36 after a switch 12 that has directed light signals toward a first output waveguide 20 can direct any light signals toward a second output waveguide 22. For instance, the switch 12 labeled B can direct any light signals toward its second output waveguide 22. This configuration reduces the opportunities for stray light signals to enter the first output waveguide 20 of a subsequent switch 12 where they can enter a common waveguide 26 as noise. One possible source of these stray signals is cross talk that results when the switch 12 labeled D direct light signals toward the first output waveguide 20.

The controller 14 can configure the switching architecture such that each common waveguide 26 carries the primary signals from only one throughput waveguide 36. For instance, the controller 14 can configure the switching architecture such that the light signals labeled S1 appear on the second common waveguide 26B and the signals labeled S2 appear on the first common waveguide 26A. The light signals labeled S1 can be made to appear on the second common waveguide 26B by controlling the switch 12 labeled A such that the light signals labeled S1 are directed toward the second output waveguide 22 and by controlling the switch 12 labeled B such that the light signals labeled S1 are directed toward the first output waveguide 20. The first output waveguide 20 of the switch 12 labeled B carries these light signals to the second common waveguide 26B. The light signals labeled S2 can be made to appear on the first common waveguide 26A by controlling the switch 12 labeled D such that the light signals labeled S2 are directed toward the first output waveguide 20. The first output waveguide 20 of the switch labeled D carries these light signals to the first common waveguide 26A.

In the configuration described above, the first common waveguide 26A carries the primary light signals labeled S2 and cross talk resulting from the switch 12 labeled A directing the light signal toward the second output waveguide 22. As a result, the common waveguides 26 can carry both cross talk and primary signals.

The controller 14 can reconfigure the switching architecture from one configuration to another by controlling the switches so as to change the mapping of light signals to common waveguides 26.

The controller 14 also controls operation of the modulators 24 on each switch. For the purposes of simplifying the operation of the switching architecture, it is presumed that that signal used to modulate the light signals in the first output of each switch 12 in communication with a particular common waveguide 26 is the same and that the modulation occurs in phase. For instance, a signal generator 38 used to generate a modulation signal can be concurrently coupled to the modulators 24 of each switch in communication with the same common waveguide 26. The same modulation signal can then be concurrently used with more than one modulator 24. Alternatively, it can be presumed that the modulation signal is the same for different switches in communication with the same common waveguide 26 but there is a time delay between the signals used to modulate the different modulators 24. In some instances, the time delay can be selected such that the modulated light signals originating from different switches are in phase once the modulated light signals enter the common waveguide 26. Accordingly, the time delay can be selected to compensate for the different distances from each switch 12 to a point on the common waveguide 26. As will be discussed in more detail below, in some instances, the modulation signal is different for one or more of the switches in optical communication with a particular common waveguide 26.

The switching architecture can be operated so as to reduce the effects of cross talk on the performance of the switching architecture. In one embodiment of a method for operating the switching architecture, each switch 12 is controlled so the light signals in the first output waveguide 20 is modulated when the switching element 18 directs a light signal to the second output waveguide 22 and the light signal in the first output waveguide 20 is not modulated when the switching element 18 directs the light signals toward the first output waveguide 20. Accordingly, cross talk in the first output waveguide 20 is modulated while primary light signals in the first output waveguide 20 are not modulated.

The light signals in the first output waveguide 20 are carried to a common waveguide 26 where they join any other light signals on the common waveguide 26. For the purposes of illustration, it is presumed that after the lights signals are combined, the common waveguide 26 carries a primary signal from one switch 12 and cross talk from one or more other switches although other combinations are possible. The combination of light signals is carried to a light sensor 28 that converts the light signals to electrical signals. Because a portion of the light signals are modulated and a portion of the light signals are unmodulated, the electrical signals have a modulated portion and an unmodulated portion. The controller 14 can include electronics 30 for extracting the unmodulated portion from the modulated portion. Because the cross talk is modulated and the primary signals are unmodulated, extracting the modulated portion of the electrical signal from the unmodulated electrical signal effectively extracts the cross talk from the electrical signal.

The electronics 30 can also include electronics 30 for processing the unmodulated portion of the electrical signal independent from the modulated portion of the electrical signal. Processing of the unmodulated portion of the electrical signal independent of the modulated portion of the electrical signal is effectively processing the primary signal without the effects of the noise that results from cross talk. Accordingly, the switches according to the present invention can reduce the effects of cross talk.

In another embodiment of a method for operating the switching architecture, each switch 12 is controlled so the light signals in the first output waveguide 20 is not modulated when the switching element 18 directs a light signal to the second output waveguide 22 and the light signal in the first output waveguide 20 is modulated when the switching element 18 directs the light signals toward the first output waveguide 20. Accordingly, cross talk in the first output waveguide 20 is not modulated while primary light signals in the first output waveguide 20 are modulated.

The light signals in the first output waveguide 20 are carried to a common waveguide 26 where they join any other light signals on the common waveguide 26. For the purposes of illustration, it is presumed that after the lights signals are combined, the common waveguide 26 carries a primary signal from one switch 12 and cross talk from one or more other switches although other combinations are possible. The combination of light signals is carried to the light sensor 28 that converts the light signals to electrical signals. Because a portion of the light signals are modulated and a portion of the light signals are unmodulated, the electrical signals can have a modulated portion and an unmodulated portion. The controller 14 can include electronics 30 for extracting the modulated portion from the unmodulated portion. Because the cross talk is unmodulated and the primary signals are modulated, extracting the unmodulated portion of the electrical signal from the modulated electrical signal effectively extracts the cross talk from the electrical signal.

The controller 14 can also include electronics 30 for processing the modulated portion of the electrical signal independent from the unmodulated portion of the electrical signal. Processing of the modulated portion of the electrical signal independent of the unmodulated portion of the electrical signal is effectively processing the primary signal without the effects of the noise that results from cross talk. Accordingly, the switches according to the present invention can reduce the effects of cross talk.

An example of electronics 30 for processing the modulated portion of the electrical signal independent from the unmodulated portion of the electrical signal includes electronics 30 for demodulating the modulated signal. Demodulating the modulated signal restores the information that was present in the primary light signal before modulation. The controller 14 can also include electronics 30 for processing of the demodulated signal.

In yet another embodiment of a method for operating the switching architecture, one or more switches 12 can be controlled so the light signals in the first output waveguide 20 is modulated with a first modulation signal when the switching element 18 directs a light signal to the second output waveguide 22 and the light signal in the first output waveguide 20 is modulated with a second modulation signal when the switching element 18 directs the light signals toward the first output waveguide 20. Examples of different modulation signals include modulation signals having different frequencies. Accordingly, cross talk in the first output waveguide 20 is modulated differently than primary light signals in the first output waveguide 20.

The light signals in the first output waveguide 20 are carried to a common waveguide 26 where they join any other light signals on the common waveguide 26. For the purposes of illustration, it is presumed that after the lights signals are combined, the common waveguide 26 carries light signals modulated with the first modulation signal and light signals modulated with the second modulation signal. The combination of light signals is carried to a light sensor 28 that converts the light signals to electrical signals. Because a portion of the light signals are modulated with the first modulation signal and a portion of the light signals are modulated with the second modulation signal, the electrical signals have a first modulated portion and a second modulated portion. The controller 14 can include electronics 30 for extracting the first modulated portion from the second modulated portion. When the first modulated portion corresponds to cross talk, extracting the first modulated portion of the electrical signal from the second modulated portion of the electrical signal effectively extracts the cross talk from the electrical signal.

The electronics 30 can also include electronics 30 for processing the first modulated portion independent of the second modulated portion and/or for processing the second modulated portion independent of the first modulated portion.

A variety of modulation schemes can be used with a switch. FIG. 3 illustrates a modulation scheme where the electronics 30 include a signal generator 38 in communication with the modulator 24 and a phase locked loop 40. The modulator 24 modulates light signals in the first output waveguide 20 using a modulation signal generated by the signal generator 38. The modulation signal is provided to the modulator 24 and the phase locked loop 40. An example of a suitable modulation signal is a voltage varying sinusoid. Other waveforms, however, may be used. For example square wave or a saw-tooth wave may also be used. When the modulator 24 is an electro-absorption modulator, a voltage varying modulation signal results in amplitude modulation of the light signals carried in the first output waveguide 20.

The modulated light signals are received at the light sensor 28 where they are converted to electrical signals. Because the common waveguide 26 will often be carrying unmodulated light signals along with the modulated light signals, the electrical signal will often include a modulated portion and an unmodulated portion. The phase locked loop 40 utilizes the modulation signal to lock to the modulated portion of the electrical signal and extract the modulation signal from the unmodulated signals. The phase locked loop 40 is implemented in accordance with known techniques and may include any number of signal comparators, filters and voltage controlled oscillators.

FIG. 4 illustrates a modulation scheme where the electronics 30 include a signal generator 38 in communication with the modulator 24 and a decoder 42. In response to the controller 14, the signal generator 38 generates a modulation signal where the modulation signal is a code signal. A suitable code signal is a pseudorandom square wave having an amplitude that varies with time and where the period of time that the signal has a particular amplitude represents a digital value of the code or a code signal such as the code signal employed in a code division multiple access (CDMA) coder. When the code signal is applied to the modulator 24 and the modulator 24 is an electro absorption modulator, the amplitude of the desired signal is modulated in accordance with the code signal. Accordingly, the signal generator 38 can serve as a coder that encodes the light signals carried in the first output.

The modulated light signals are carried on the common waveguide 26 to the light sensor 28 where they are converted to electrical signals. Because the common waveguide 26 will often be carrying unmodulated light signals along with the modulated light signals, the electrical signal will often include a modulated portion and an unmodulated portion. The decoder 42 applies an appropriate decoding signal to the electrical signals to extract the modulated portion of the light signal. For example, the decoder 42 can receive the code signal from the signal generator 38 and employ the code signal to extract the modulated portion of the electrical signal. In one instance, the decoder 42 is a CDMA decoder 42. The coding-decoding techniques are performed in accordance with known techniques and may include various aspects not explicitly discussed herein that will be apparent to those skilled in the art. For example, a synchronization mechanism or technique may be used to synchronize the coder to the decoder 42.

FIG. 5 illustrates a modulation scheme where the electronics 30 include signal generator 38 and a filter 44. The modulator 24 modulates light signals in the first output waveguide 20 using a modulation signal generated by the signal generator 38. The modulation signal is provided to the modulator 24 and the phase locked loop 40. An example of a suitable modulation signal is a voltage varying sinusoid. Other waveforms, however, may be used. For example square wave or a saw-tooth wave may also be used. When the modulator 24 is an electro-absorption modulator, a voltage varying modulation signal results in amplitude modulation of the light signals carried in the first output waveguide 20.

The modulated light signals are carried on the common waveguide 26 to the light sensor 28 where they are converted to electrical signals. Because the common waveguide 26 will often be carrying unmodulated light signals along with the modulated light signals, the electrical signal will often include a modulated portion and an unmodulated portion. The filter 44 is configured to extract the modulated portion of the light signal from the unmodulated portion of the light signal.

In some instances, the filter 44 has a fixed frequency and bandwidth that encompasses the frequency of the modulation signal. However, the filter 44 can be tunable to a particular range of frequencies. Accordingly, when the frequency of the modulation signal is changed, the filter 44 can be tuned to the new frequency. Alternatively, when the light signals from one switch 12 are modulated at a different frequency than the light signals from another switch, the filter 44 can be tuned to so as to extract the modulated portion of the electrical signal that originated from a particular one of the switches.

In some instances, the above modulation schemes allow the electronics 30 to separate out the primary signals originating from different switches. As a result, a common waveguide 26 can carry light signals from more than one switch. For instance, when the modulation scheme discussed with the respect to FIG. 4 is operated such that the primary signals are coded while the cross talk is uncoded, the light signals from different switches can be coded using different codes. By extracting the portion of the electrical signal exhibiting a particular code, the primary light signal originating from a particular switch 12 can be extracted without the noise of cross talk. Alternatively, the electronics 30 can be configured to extract the primary light signal originating at more than one switch 12 by employing techniques similar to CDMA systems that allow more than one cellular phone user to use a channel. As an additional example, when the modulation scheme discussed with the respect to FIG. 5 is operated such that the primary signals are coded while the cross talk is uncoded, the modulators 24 from different switches can modulate the light signals at different frequencies. The electronics 30 can include a plurality of filters that each filter out a different frequency bandwidth. The bandwidth of each filter can correspond to the frequency of a modulation signal used on one of the switches. Accordingly, the output of each filter will correspond to the primary signal from the switch 12 using a modulation signal with a frequency falling within the bandwidth of the filter.

Although the above discussions of the modulations schemes is disclosed in the context of amplitude based modulation of the light signals, the modulation schemes can be adapted for use with other light signal modulation techniques such as phase based modulation of the light signals or frequency based modulation of the light signals.

FIG. 6A is a schematic illustration of a switch. The intersection of a common waveguide 26 and a throughput waveguide 36 defines four reflector regions. The first reflector region, the second reflector region, the third reflector region and the fourth reflector region are labeled I, II, III and IV respectively. The first reflector region is positioned between the portion of the common waveguide 26 that carries light signals away from the intersection of the common waveguide and the throughput waveguide and the portion of the throughput waveguide that carries light signals away from the intersection of the common waveguide and the throughput waveguide. The second reflector region, the third reflector region and the fourth reflector region are then defined by counting upwards while moving counterclockwise from the first reflector region. Although the reflector regions are shown as being defined by ninety degrees angles, the reflector regions can be defined by other angles when the common waveguide 26 and the throughput waveguide 36 do not intersect at right angles.

The first output waveguide 20 includes a reflector 48 positioned in the second reflector region at the junction of a first branch 50A and a second branch 50B. The reflector 48 serves to reflect light signals from the first branch 50A into the second branch 50B. The reflector 48 is positioned such that the light signals in the first output waveguide 20 cross a common waveguide 26 and a throughput waveguide 36 before being combined with the light signals on the common waveguide 26. Optical loss occurs each time these light signals cross a waveguide. Additionally, the location of the reflector 48 in the second reflector region means that the angle, θ, between the first branch 50A and the second branch 50B must be less than 90 degrees. Accordingly, the light signals in the first branch 50A impinge on the reflector 48 at a low angle of incidence. The low angle of incidence can result in the light signals being transmitted through the reflector 48 rather than being reflected. Accordingly, the low angle, θ, can also result in increased optical losses.

FIG. 6B, FIG. 6C and FIG. 6D are schematic illustrations of switching architectures associated with a reduced degree of optical loss. FIG. 6B illustrates the reflector 48 positioned in the first reflector region; FIG. 6C illustrates the reflector 48 positioned in the third reflector region; and FIG. 6D illustrates the reflector 48 positioned in the fourth reflector region. In FIG. 6B, the first output waveguide 20 crosses only a common waveguide 26 while in FIG. 6C, the first output waveguide 20 crossed only the input waveguide 16. In FIG. 6D, the first output waveguide 20 does not cross over any waveguides. Accordingly, in FIG. 6B through FIG. 6D illustrate the reflector 48 positioned so as to reduce the number waveguide intersections associated with the first output waveguide 20. Reducing the number of waveguide intersections associated with the switch reduces the optical loss associated with the switch.

Additionally, the positions of the reflectors 48 in FIGS. 7B through FIG. 6D allow the angle, θ, between the first branch 50A and the second branch 50B to be increased to greater than 90 degrees. Increasing these angles increases the percentage of each light signal that is reflected by the reflector 48 and not transmitted through the reflector 48 and brings the reflector 48 closer to total internal reflection. In some instances, the angle, θ, is greater than 100 degrees, 110 degrees, 120 degrees, 130 degrees, 140 degrees, 150 degrees or 160 degrees. In other instances, the angle T is between 100 degrees and 140 degrees or between 110 degrees and 130 degrees.

FIG. 6E is another schematic illustrations of a switching architecture associated with a reduced degree of optical loss. The first output waveguide 20 is curved and does not cross other waveguides on the switch. The modulator 24 can be formed on a curved region of the first output waveguide 20 or the first output waveguide 20 can include a straight region where the modulator 24 is positioned. Curving the first output waveguide 20 eliminates the need for the reflector 48 and accordingly, eliminates the optical losses associated with the reflector 48. As a result, the switching architecture is associated with a reduced optical loss.

Although the schematics of FIG. 6A through FIG. 6E illustrate the throughput waveguides 36 intersecting the common waveguides 26 at right angles, the throughput waveguides 36 can intersect the common waveguides 26 at other angles to improve the performance of the switch. For instance, changing the angle between the common waveguides 26 and the throughput waveguides 36 can further increase the angle, θ, between the first and second branch 50Bes of the first output waveguide 20.

Although the embodiments illustrated in FIG. 6A through FIG. 6E show each switch 12 including a modulator 24, the modulator 24 is not required.

FIG. 7A is a perspective view of an optical component 54 including a switching architecture. FIG. 7B is a cross section of FIG. 7A taken at any of the lines labeled A. The component 54 includes a light transmitting medium 56 positioned over a base 58. A suitable light transmitting medium 56 includes, but is not limited to, silicon.

The light transmitting medium 56 includes a plurality of ridges 60. In some instances, the ridge 60 has a thickness greater than 4 μm, 8 μm, 10 μm, greater than 12 μm or greater than 14 μm measured from the base 58. The height of the ridge 60 is generally about 30 to 70% of the ridge 60 thickness. In some instances, the height of the ridge 60 is 40 to 60% of the ridge 60 thickness. In other instances, the height of the ridge 60 is 2.5 to 12 μm or 3 to 10 μm. The base 72 of the ridge 60 is generally narrower than the thickness of the ridge 60 although the base 72 of the ridge 60 can be larger than the thickness of the ridge 60. In some instances, the width of the ridge 60 at the base 72 of the ridge 60 is greater than 30, 40, 50, 70 or 90% of the thickness of the ridge 60. In other instances, the width of the ridge 60 at the base 72 of the ridge 60 is between 30 and 100% of the ridge 60 thickness.

Each ridge 60 defines a portion of the light signal carrying region of a waveguide 62. The portion of the base 58 under the ridge 60 includes a material configured to reflect light signals from the light signal carrying region back into the light signal carrying region. Accordingly, the base 58 also defines a portion of the light signal carrying region. The profile of a light signal traveling along a light signal carrying region is illustrated by the line labeled A in FIG. 7B.

The component 54 includes a plurality of switches. Each switch 12 includes an input waveguide 16, a first output waveguide 20 and a second output waveguide 22. A switching element 18 is positioned so as to direct light signals to the first output waveguide or the second output waveguide. A modulator 24 is positioned along the first output waveguide 20. A portion of the first output waveguides 20 are in optical communication with a first common waveguide 26A and another portion of the first output waveguide 20 are in optical communication with a second common waveguide 26B. The input waveguide 16 and second output waveguide 22 of a portion of the switches are connected so as to form a first throughput waveguide 36A and the input waveguide 16 and second output waveguide 22 of another portion of the switches are connected so as to form a second throughput waveguide 36B.

A light sensor 28 is illustrated as being positioned at the end of each common waveguide 26. However, an optical fiber can couple each common waveguide to a light sensor 28.

The component 54 illustrated in FIG. 7A is an embodiment of the schematic illustrated in FIG. 6D. However, the component 54 illustrated in FIG. 7A can be adapted to be an embodiment of any of the schematics illustrated in FIG. 6A through FIG. 6E. For instance, the first output waveguide 20 illustrated in FIG. 7A can be curved and the reflector 48 eliminated to provide the curved first output waveguide 20 shown in FIG. 6E. Another embodiment of a waveguide 62 suitable for serving as the curved first output waveguide 20 of FIG. 6E is taught in U.S. patent application Ser. No. 09/756,498, entitled “An Efficient Curved Waveguide”, filed on Jan. 8, 2001 and incorporated herein in its entirety. As noted above, the modulator 24 can be formed on a curved portion of the curved first output waveguide 20 or the curved first output waveguide 20 can include a straight region where the modulator 24 is positioned.

The base 58 can have a variety of constructions. FIG. 8A illustrates a component 54 having a base 58 with a light barrier 64 positioned over a substrate 66. The light barrier 64 serves to reflect the light signals from the light signal carrying region back into the light signal carrying region. The light barrier 64 can have reflective properties such as a metal. Alternatively, the light barrier 64 can have a lower index of refraction than the light transmitting medium 56. For instance, the light barrier 64 can be silica when the light transmitting medium 56 is silicon. The drop in the index of refraction causes reflection of light signals from the light signal carrying region back into the light signal carrying region. A suitable substrate 66 includes, but is not limited to, a silicon substrate 66.

The light barrier 64 need not extend over the entire substrate 66 as shown in FIG. 8B. For instance, the light barrier 64 can be an air filled pocket formed in the substrate 66. The pocket can extend alongside the light signal carrying region so as to define a portion of the light signal carrying region.

In some instances, the light signal carrying region is adjacent to a surface 68 of the light barrier 64 and the light transmitting medium 56 is positioned adjacent to the sides 70 of the light barrier 64. As a result, light signals that exit the light signal carrying region can be drained from the waveguide 62 as shown by the arrow labeled A. These light signals are less likely to enter adjacent waveguides. Accordingly, these light signals are not significant source of cross talk. The drain effect can also be achieved by placing a second light transmitting medium adjacent to the sides 70 of the light barrier 64 as indicated by the region below the level of the top dashed line or by the region located between the dashed lines. The drain effect is best achieved when the second light transmitting medium has an index of refraction that is greater than or substantially equal to the index of refraction of the light transmitting medium 56 positioned over the base 58. In some instances, the bottom of the substrate 66 can include an anti reflective coating that allows the light signals that are drained from a waveguide 62 to be exit the component 54.

In some instances, the width of the light barrier 64 is larger than 150% of the width of the base 72 of the ridge 60. In other instances, the width of the light barrier 64 is less than 150% of the width of the base 72 of the ridge 60, less than 140% of the width of the base 72 of the ridge 60, less than 130% of the width of the base 72 of the ridge 60, less than 120% of the width of the base 72 of the ridge 60, less than 110% of the width of the base 72 of the ridge 60, less than 100% of the width of the base 72 of the ridge 60.

The input waveguide 16, the first output waveguide 20 and/or the second output waveguide 22 can be formed over a light barrier 64 having sides 70 adjacent to a light transmitting medium 56. Additionally, all, none or a portion of the common waveguides 26 and/or throughput waveguides 36 can be formed over a barrier having sides 70 adjacent to a light transmitting medium 56.

The drain effect can play an important role in improving the performance of optical switches because there are a large number of waveguides formed in close proximity to one another. The proximity of the waveguides tends to increase the portion of light signals that act as a source of cross talk by exiting one waveguide and entering another. The drain effect reduces this source of cross talk in switches.

Other base 58 and component constructions suitable for use with a component such as the component 54 illustrated in FIG. 7A are discussed in U.S. patent application Ser. No. 09/686,733, filed on Oct. 10, 2000, entitled “Waveguide Having a Light Drain” and U.S. patent application Ser. No. 09/784,814, filed on Feb. 15, 2001, entitled “Component Having Reduced Cross Talk” each of which is incorporated herein in its entirety.

FIG. 9A illustrates an example of a modulator 24 that can be used in conjunction with the component 54 illustrated in FIG. 7A. The illustrated modulator 24 is an electro-absorption modulator that can provide amplitude based modulation. A first electrical contact 74A is positioned over the ridge 60 and a second electrical contact 74B is positioned adjacent to a side of the ridge 60. Electrical conductors such as wires can optionally be connected to the electrical contacts 74 for application of a potential between the electrical contacts 74. Forming a metal layer on the component 54 can form the first electrical contacts 74A. Suitable metals include, but are not limited to, Ni, Cr, Ti, Tungsten, Au, Ct, Pt, Al and/or their silicides. The metal layer can be formed to a thickness greater than 0.1 μm, 0.5 μm, 1 μm, 1.5 μm or 2 μm.

FIG. 9B is a cross section of the modulator 24 illustrated in FIG. 9A taken at the line labeled A. A doped region 76 is formed adjacent to each of the electrical contacts 74. The doped regions 76 can be N-type material or P-type material. When one doped region 76 is an N-type material, the other doped region 76 is a P-type material. For instance, the doped region 76 adjacent to the first electrical contact 74A can be a P type material while the material adjacent to the second electrical contact 74B can be an N type material. In some instances, the regions of N type material and/or P type material are formed to a concentration of 10ˆ (17-21)/cm³ at a thickness of less than 6 μm, 4 μm, 2 μm, 1 μm or 0.5 μm. The doped region can be formed by implantation or impurity diffusion techniques.

FIG. 9C illustrates operation of an embodiment of the component 54 illustrated in FIG. 9A and FIG. 9B. During operation of the electro-absorption modulator 14, a potential is applied between the electrical contacts 74. The potential causes the index of refraction of the first light transmitting medium 56 positioned between the electrical contacts 74 to change as shown by the lines labeled B.

When the potential on the electrical contact 74 adjacent to the P-type material is less than the potential on the electrical contact 74 adjacent to the N-type material, a current flows through the light transmitting medium 56 and the index of refraction decreases. The reduced index of refraction causes at least a portion of the light signals to be reflected out of the light signal carrying region as illustrated by the arrow labeled C. When a light transmitting medium 56 is positioned adjacent to the sides 70 of the light barrier 64 as is shown in FIG. 9C, the light signals can enter the substrate 66 and be drained away from the modulator 24 so they can not enter other waveguides. Because the light signals are reflected out of the light signal carrying region, the light signal carrying region carries a reduced portion of the light signals. As a result, a light signal exiting the electro-absorption modulator has less intensity than the light signal that entered the electro-absorption modulator.

The larger the potential applied between the electrical contacts 74, the higher the degree of modulation that occurs. As a result, applying a modulation signal with a varying potential to the modulator 24 produces a light signal having a varying intensity.

Although a portion of the second electrical contact is illustrated as being positioned over the light barrier, all or none of the second electrical contact can be positioned over the light barrier. Additionally, the electro-absorption modulator will work in conjunction with a light barrier 64 that is continuous across a substrate 66 as shown in FIG. 8A.

Other embodiments of suitable modulators 24 and methods of manufacturing are discussed in U.S. patent application Ser. No. 09/778,285, filed on Jan. 18, 2001, entitled “Optical Attenuators” and incorporated herein in its entirety.

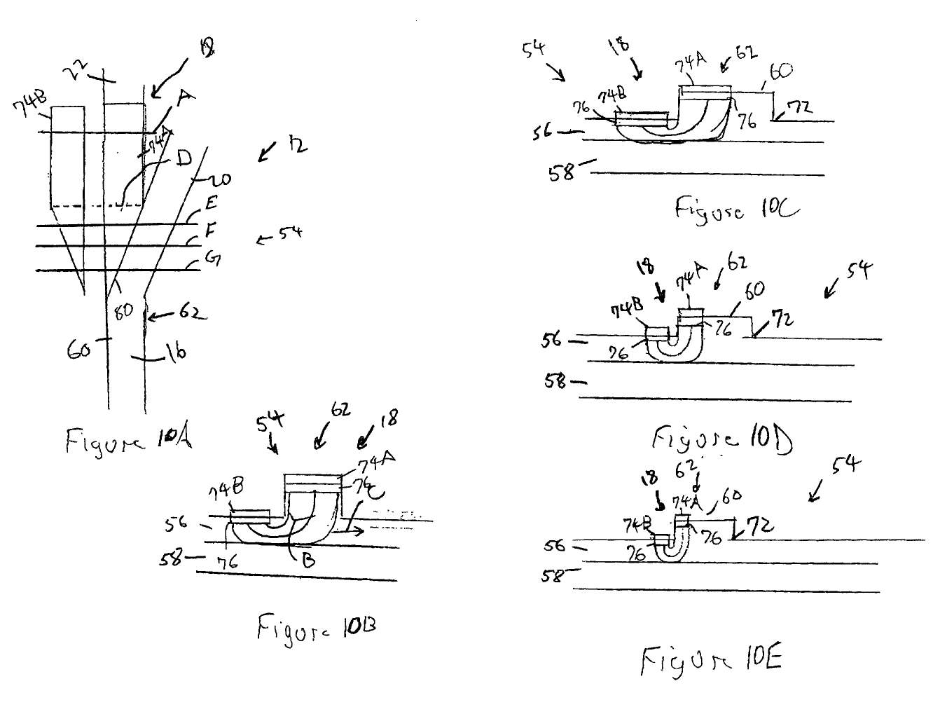

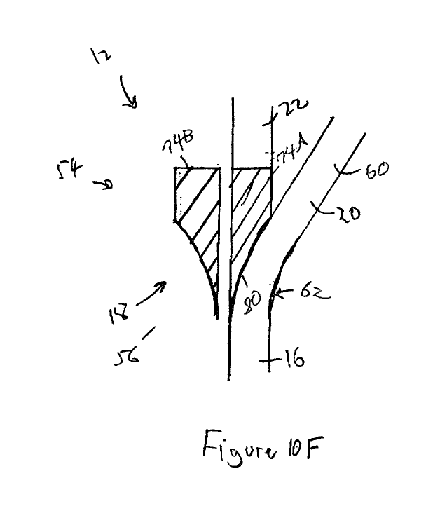

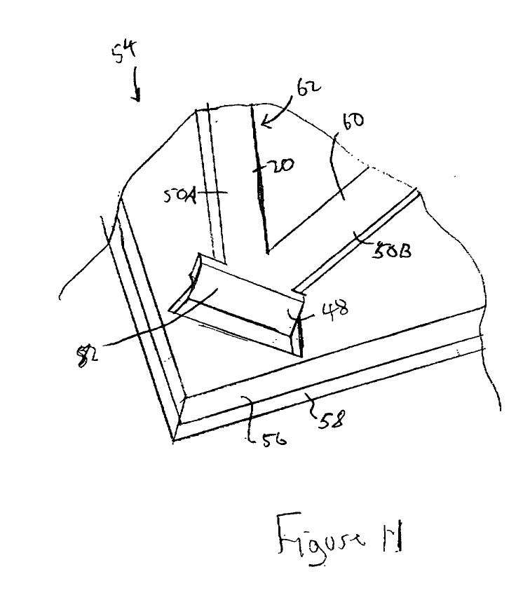

FIG. 10A is a top view of a switching element 18 that is suitable for use with the optical component 54 illustrated in FIG. 7A. The switching element 18 is configured to direct a light signal from an input waveguide 16 to a first output waveguide 20 or a second output waveguide 22. The switching element 18 includes a first electrical contact 74A positioned over the ridge 60 and a second electrical contact 74B positioned adjacent to a side of the ridge 60. Electrical conductors such as wires can optionally be connected to the electrical contacts 74 for application of a potential between the electrical contacts 74.

FIG. 10B is a cross section of the switching element 18 illustrated in FIG. 10A taken at the line labeled A. A doped region 76 is formed adjacent to each of the electrical contacts 74. The doped regions 76 can be N-type material or P-type material. When one doped region 76 is an N-type material, the other doped region 76 is a P-type material. For instance, the doped region 76 adjacent to the first electrical contact 74A can be a P type material while the material adjacent to the second electrical contact 74B can be an N type material. In some instances, the regions of N type material and/or P type material are formed to a concentration of 10ˆ (17-21)/cm³ at a thickness of less than 6 μm, 4 μm, 2 μm, 1 μm or 0.5 μm. The doped region can be formed by implantation or impurity diffusion techniques.

The switching element 18 is operated by applying a potential between the first electrical contact 74A and the second electrical contact 74B. The potential causes the index of refraction of the first light transmitting medium 56 positioned between the first electrical contact 74A and the second electrical contact 74B to change as shown by the lines labeled B in FIG. 10B. Because the first electrical contact 74A is positioned over the ridge 60, the index of refraction of the light transmitting medium 56 in the ridge 60 is changed. As a result, positioning one of the electrical contacts 74 over the ridge 60 increases the portion of the light signal carrying region that undergoes a change in the index of refraction and accordingly increases the efficiency of the switching element 18.

When the potential on the electrical contact 74 adjacent to the P-type material is less than the potential on the electrical contact 74 adjacent to the N-type material, a current flows through the light transmitting medium 56 and the index of refraction decreases. The reduced index of refraction causes the light signals to be reflected in the direction of the arrow labeled C. Reflecting the light signal in the direction of the arrow labeled C directs the lights signals into the first output waveguide 20. The potential is applied at a level that causes substantially the entire substantially light signal to be directed toward the first output waveguide 20.

A light signal can be directed toward the second output waveguide 22 by not applying a potential between the first electrical contact 74A and the second electrical contact 74B. The light signal travels from the input waveguide 16 to the second output waveguide 22 without any effects from a changing index of refraction. Alternatively, a potential can be applied so the potential on the electrical contact 74 adjacent to the P-type material is greater than the potential on the electrical contact 74 adjacent to the N-type material. This arrangement increases the index of refraction of the material positioned between the electrical contacts 74 and accordingly increases retention of the light signal in the region where the index of refraction is changed. As a result, the light signals are less likely to enter the first output waveguide 20 and cross talk can be reduced.

The leading edge 80 of the first electrical contact 74A is the side of the first electrical contact 74A that first interacts with a light signal traveling through a switch. FIG. 10A illustrates a first electrical contact 74A having a contoured leading edge 80. More specifically, the leading edge 80 of the first electrical contact 74A is not at a right angle relative to the direction of propagation of light signals traveling along the input waveguide 16. Previous electrical contacts 74 had a blunt edge as illustrated by the dashed line labeled D. The dashed line illustrates a leading edge 80 that is perpendicular to direction of propagation of light signals traveling along the input waveguide 16. The blunt edge resulted in a large portion of each light signal being reflected back into the input waveguide 16. As a result, the blunt edge was a large source of optical loss.

The contour of the leading edge 80 can extend the contour of the first output waveguide 20. For instance, the leading edge 80 of the first electrical contact 74A illustrated in FIG. 10A extends the contour of the first output waveguide 20. The contour of the first electrical contact 74A causes the region of the light transmitting medium 56 where the index of refraction change occurs to also be contoured as illustrated in FIG. 10C, FIG. 10D and FIG. 10E. FIG. 10C, FIG. 10D and FIG. 10E are cross sections of the component 54 shown in FIG. 10A taken at the line labeled E, F and G respectively. A potential is applied to the electrical contacts 74 so as to change the index of refraction of the light transmitting medium 56 positioned between the electrical contacts 74. The further the first electrical contact 74A extends over the light signal carrying region, the further the region where the index of refraction has changed extends into the light signal carrying region. As a result, the contour of the first electrode results in a contour of the region where the index of refraction has changed.

Changing the contour of the region where the index of refraction change occurs provides the light signal with a more gradual transition from the input waveguide 16 to the first output waveguide 20. The more gradual transition reduces the amount of optical loss that occurs at the switching element 18 by reducing the portion of each light signal that is reflected or scattered out of the waveguides 62.

Although the leading edge 80 is shown as being straight, the leading edge 80 can have a curved shape such as would extend the contour of a first output waveguide 20 constructed according to FIG. 6E. Additionally, the leading edge 80 can have a contour that is different than the contour of the first output waveguide 20 as shown in FIG. 10F. For instance, the leading edge 80 can have a curved contour in contrast to the straight contour of the first output waveguide 20. The curved shape can provides a more gradual transition from the input waveguide 16 to the first output waveguide 20 than would be achieved by extending the contour of first output waveguide 20.

As shown in FIG. 10F, the side of the waveguide(s) 62 opposite the leading edge 80 of the first electrical contact 74A can optionally be contoured to match the contour of the leading edge 80. As a result, the side opposite the leading edge 80 can have a curved shape when the leading edge 80 has a curved shape. The contour of the side opposite the leading edge 80 can be selected so that a substantially constant distance is maintained between the leading edge 80 and the side. The substantially constant distance helps preserve a substantially constant waveguide width during the transition form the input waveguide 16 to the first output waveguide 20. A constant waveguide width can reduce excitation of modes other than the fundamental mode.

As illustrated, the second electrical contact 74B can have a shape that is complementary to the first electrical contact 74A. However, the shape of the second electrical contact 74B need not be complementary to the shape of the first electrical contact 74A.

Although the leading edge 80 is illustrated as being positioned substantially parallel with a side of the first output waveguide 20, the leading edge 80 can be offset relative to the first output waveguide 20. For instance, the leading edge 80 can be shifted further toward the input waveguide 16 to compensate for any dissipation in the current or other current variations.

Other suitable switching elements 18 are disclosed in U.S. patent application serial number (Not yet assigned), filed on Sep. 15, 2000, entitled “Integrated Optical Cross Point Switch Array Based on Hybrid Digital Mode Operation” and incorporated herein in its entirety.

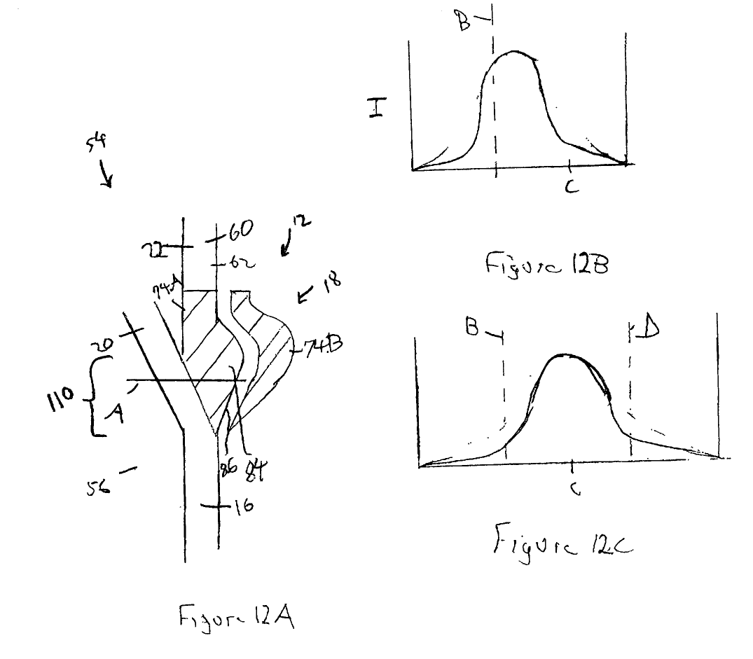

FIG. 11 is a perspective view of a reflector 48 suitable for use with the component 54 illustrated in FIG. 7A. The reflector 48 includes a surface 82 extending through the light transmitting medium 56 to the base 58. The surface 82 extends to the base 58 because the light signals are carried below the ridge 60 as well as in the ridge 60. As a result, extending the reflector 48 below the ridge 60 increases the portion of the light signal that is reflected at the reflector 48. U.S. patent application Ser. No. 09/723,757, filed on Nov. 28, 2000, entitled “Formation of a Reflecting Surface on an Optical Component” and incorporated herein in its entirety teaches a suitable method of fabricating a component having the reflector 48 illustrated in FIG. 11.

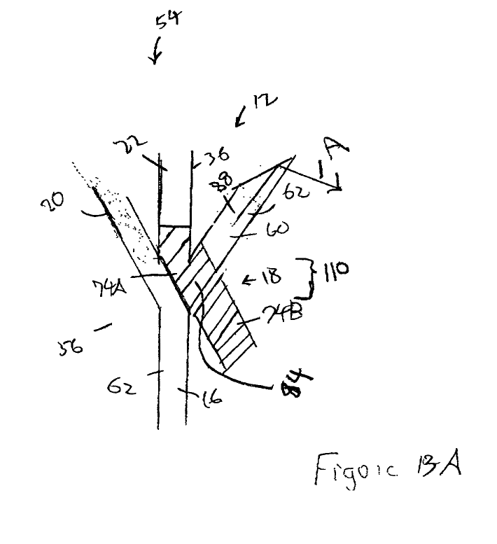

FIG. 12A illustrates a junction of the input waveguide 16, the first output waveguide 20 and the second output waveguide 22 suitable for use with the component 54 illustrated in FIG. 7A. The input waveguide 16 includes an expanded region 84 opposite the first output waveguide 20. The perimeter of the expanded region 84 extends away from the first output waveguide 20 and then rejoins either the input waveguide 16 or the second output waveguide 22. Other suitable expanded regions 84 are disclosed in (Not yet assigned), filed on Sep. 15, 2000, entitled “Integrated Optical Cross Point Switch Array Based on Hybrid Digital Mode Operation” and incorporated herein in its entirety.

The expanded region 84 can reduce cross talk. FIG. 12B illustrates the intensity profile of a light signal traveling through the switch 12 at the line labeled A in FIG. 12A when the expansion region is not present. The line labeled B illustrates the left side of the second output waveguide projected onto the line labeled A and the point labeled C illustrates the location of the center of the first output waveguide 20. Because the light signal expands to fill the available space, the light signal shifts toward the first output waveguide 20. As a result, the portion of the light signal to the left of the line labeled B will be lost on the first output waveguide 20.

FIG. 12C illustrates the intensity profile of a light signal located at the line labeled A in FIG. 12A when the expansion region is present. The line labeled B illustrates the left side of the second output waveguide projected onto the line labeled A. The line labeled D illustrates the point where the input waveguide 16 would end without the expansion region. Because the light signal expands to fill the available space and the available space expands in both directions relative to the input waveguide 16, the light signal remains centered relative to the second output waveguide 22. Accordingly, the portion of the light signal located to the left of the line labeled B is much smaller in FIG. 12C than FIG. 12B. Hence, the amount of the light signal entering the first output waveguide 20 is reduced.

The first output waveguide and the second output waveguide share a region of the switch. In some instances, the leading edge 86 of the expanded region 84 has a geometry that mirrors the geometry of the portion of the first output waveguide 20 opposite the leading edge 86. This shape provides the shared region 110 with a symmetrical shape about an axis that is parallel to a direction of propagation of light signals traveling along the input waveguide at a location where the input waveguide meets the shared region 110. The symmetry can extend only from the location where the input waveguide meets the shared region 110 through the shared region 110. Accordingly, the symmetrical nature of the shared region 110 can end outside the shared region 110. Because the second output waveguide is centered relative to the input waveguide, the symmetrical nature of the shared region 110 shifts the light signals toward the center of the second output waveguide.

Although the junction is illustrated as having a symmetrical shared region, the expanded region need not be shaped to provide a symmetrical shared region. For instance, the second output waveguide can have a center that is shifted to the right relative to the input waveguide as would result if the junction were a Y shape junction. The expanded region can have a shape that shifts the light signals toward the center of the second output waveguide, however, the shared region would not necessarily have a symmetrical shape.

The first electrical contact 74A of the switching element 18 can extend over all or a portion of the expanded region 84. This configuration reduces the amount of cross talk that results when the switching element 18 directs a light signal toward the first output waveguide 20. More specifically, this configuration reduces the portion of a light signal that enters the second output waveguide 22 when the light signal is directed toward the first output waveguide 20. Additionally, this configuration can provide a light signal with a smoother transition from the input waveguide 16 to the first output waveguide 20 as reviewed in conjunction with the discussion of FIG. 10E through FIG. 10G.

The second electrical contact 74B has a shape that is configured to promote an even flow of current between the first electrical contact 74A and the second electrical contact 74B. To encourage an even current flow, the portion of the second electrode adjacent to narrow regions of the first electrical contact 74A are also narrow while the portion of the second electrode adjacent to the wider regions of the first electrical contact 74A have an increased width. The even flow of current provides a more uniform change in the index of refraction than occurs when there large inconsistencies in the current flow.

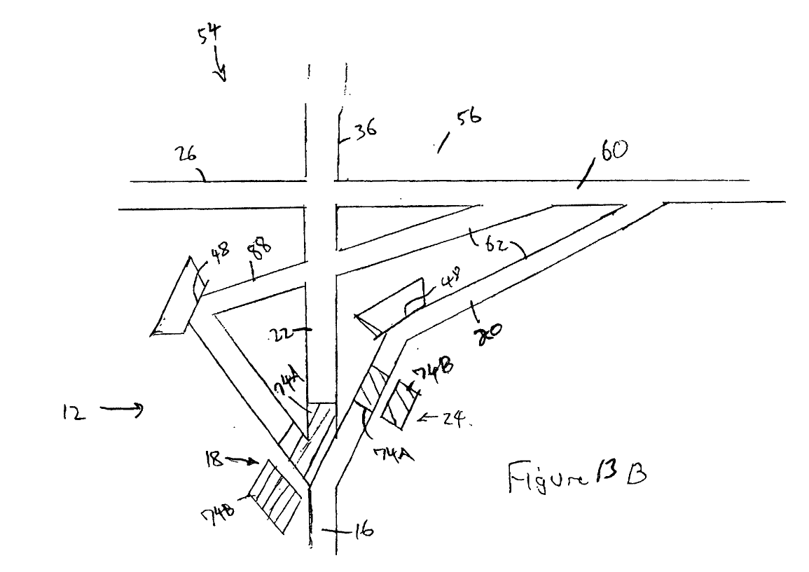

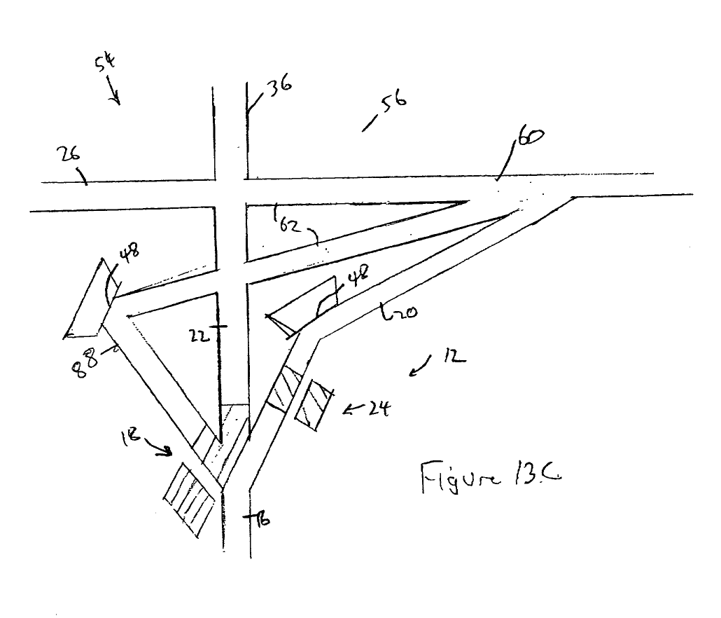

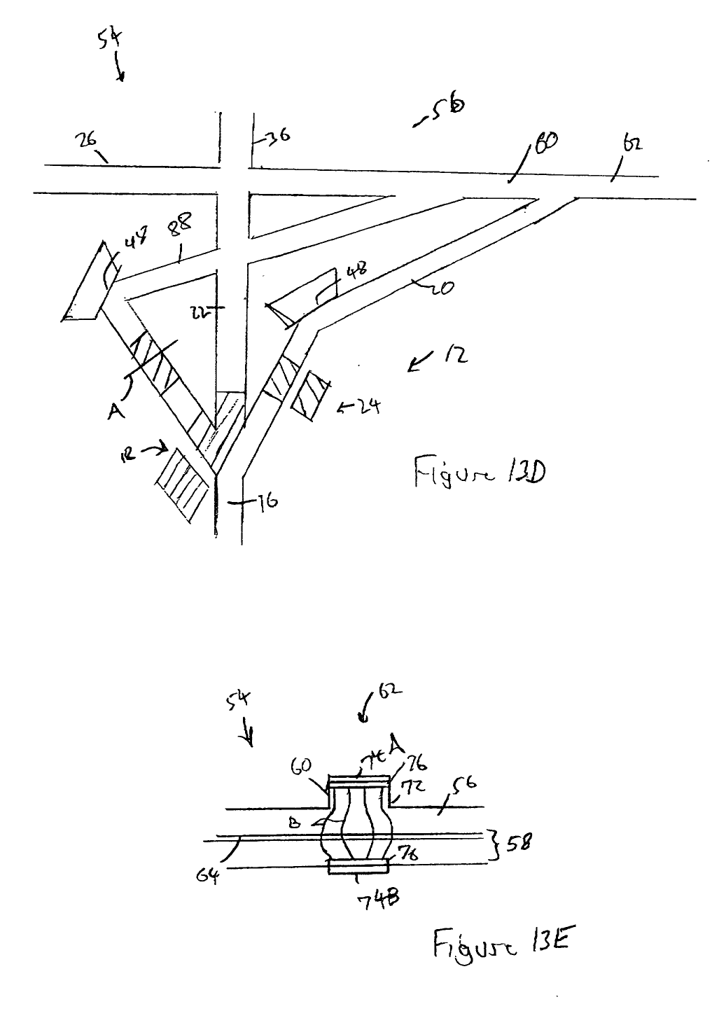

The expanded region 84 can also be included in a third output waveguide 88 as illustrated in FIG. 13A. The switching element is configured to direct the light signal to the first output waveguide or to the second output waveguide but is not configured to direct light signals to the third output waveguide. Accordingly, the first output waveguide and the second output waveguides serve as active output waveguides while the third output waveguide serves as a secondary output waveguide.

The first electrical contact can extend over the expanded region 84 as shown in FIG. 13A in order to reduce the portion of the light signals that enters the third output waveguide when the light signals are directed toward the first output waveguide.

The first output waveguide, the second output waveguide and the third output waveguide share a region of the switch. The third output waveguide can be shaped so the shared region 110 has a symmetrical shape about an axis parallel to a direction of propagation of light signals traveling along the input waveguide at a location where the input waveguide meets the shared region 110. Because the second output waveguide is centered relative to the input waveguide, the symmetrical nature of the shared region 110 shifts the light signals toward the center of the second output waveguide. However, a portion of the light signal will enter the third output waveguide when the light signals are directed to the third output waveguide.

The symmetry can extend only from the location where the input waveguide meets the shared region 110 through the shared region 110. Accordingly, the symmetrical nature of the shared region 110 can end outside the shared region 110. However, the symmetry can extend to the terminal end of the third output waveguide.

Although the junction is illustrated as having a symmetrical shared region, the expanded region need not be shaped to provide a symmetrical shared region. For instance, the second output waveguide can have a center that is shifted to the right relative to the input waveguide as would result if the junction of the first output waveguide and the second output waveguide were a Y shape junction. The third output waveguide would be shaped to shift the light signals toward the center of the second output waveguide, however, the shared region would not necessarily have a symmetrical shape.

The third output waveguide 88 can optionally have a terminal end 90 that is angled at less the ninety degrees relative to the direction of propagation of light signals traveling along the third output waveguide 88. Suitable angles for the terminal end include, but are not limited to, less than 89 degrees, less than 88 degrees, less than 85 degrees and less than 80 degrees relative to the direction of propagation of light signals traveling along the third output waveguide. In some instances, the angle is between 80 and 85 degrees or 82 and 84 degrees.

The angled end 90 can reflect light signals traveling along the third output waveguide 88 out of the third output waveguide 88 as shown by the arrow labeled A. The light signals reflected out of the third output waveguide 88 can be drained from the optical component 54 in embodiments of the base 58 where a light transmitting medium 56 is positioned adjacent to the sides 70 of the light barrier 64. The terminal end 90 can include an antireflective coating to further encourage light signals to be reflected out of the third output waveguide 88.

The third output waveguide 88 can be in optical communication with a common waveguide 26 as illustrated in FIG. 13B. The third output waveguide 88 can be chosen to have a length that causes the light signals that enter the third output waveguide 88 to have destructive interference with the cross talk that enters the common waveguide 26 through the first output waveguide 20. For instance, the third output waveguide 88 can be designed with a length that causes a light signal traveling in the common waveguide 26 from the third output waveguide 88 to be 180 degrees out of phase with the same light signal traveling in the common waveguide 26 from the first output waveguide 20. Because about the same portion of the light signal enter the first output waveguide 20 and the third output waveguide 88 when the light signal is directed toward the second output waveguide 22, the destructive interference can effectively eliminate the cross talk. However, when the light signal is directed toward the first output waveguide 20, the portion of the light signal entering the first output waveguide 20 will be much larger than the portion of the light signal entering the third output waveguide 88. As a result, any destructive interference will not affect the performance of the switch.

Because an input waveguide 16 will often carry light signals of more than one wavelength, destructive interference will often be achieved with only one of the light signals and only partially achieved with the remaining light signals. Accordingly, in some instances, the third output waveguide 88 is designed so as to achieve destructive interference with respect to the light signal having the wavelength nearest the average of the light signal wavelengths. In other instances, a particular light signal wavelength is targeted.

Although the first output waveguide 20 is illustrated as including a reflector 48 in FIG. 13B, the first output waveguide 20 and/or the third output waveguide 88 can be curved as shown in FIG. 6E. Additionally, the first output waveguide 20 and the third output waveguide 88 are shown as joining the common waveguide 26 at different locations. However, the third output waveguide 88 and the first output waveguide 20 can be combined into a single waveguide before joining the common waveguide 26. Alternatively, the first output waveguide 20 and the third output waveguide 88 can join at the common waveguide 26 as shown in FIG. 13C. Because each waveguide junction is associated with some degree of optical loss, reducing the number of waveguides that join a common waveguide 26 reduces the optical loss associated with the switch.

FIG. 13D illustrates an embodiment of the switch 12 where the third output waveguide 88 includes an effective length tuner 94. Although not illustrated, the controller 14 controls the effective length tuner 94. The controller 14 can use the effective length tuner 94 to increase or decrease the effective length of the third output waveguide 88. Increasing or decreasing the effective length of the third output waveguide 88 allows the amount of destructive interference to be tuned for a particular light signal. More specifically, changing the effective length of the third output waveguide 88 changes the phase difference between a light signal traveling on the common waveguide 26 from the third output waveguide 88 and the same light signal traveling on the common waveguide 26 from the first output waveguide 20. As a result, the effective length tuner 94 can be used to improve the level of destructive interference for a targeted light signal. Alternatively, the effective length tuner 94 can be used to target another wavelength light signal for destructive interference.

The effective length tuner 94 can operate by changing the index of refraction of the material in the light signal carrying region. For instance, increasing the index of refraction of the material in the light signal carrying region increases the effective length of the third output waveguide 88 while decreasing the index of refraction of the material in the light signal carrying region decreases the effective length of the third output waveguide 88.

An example of an effective length tuner 94 is illustrated in FIG. 13E. FIG. 13E is a cross section of the component 54 of FIG. 13D taken at the line labeled A. The effective length tuner 94 includes a first electrical contact 74A positioned over the ridge 60 and a second electrical contact 74B positioned under the ridge 60 on the opposite side of the component 54. A doped region 76 is formed adjacent to each of the electrical contacts 74. The doped regions 76 can be N-type material or P-type material. When one doped region 76 is an N-type material, the other doped region 76 is a P-type material. For instance, the doped region 76 adjacent to the first electrical contact 74A can be a P type material while the material adjacent to the second electrical contact 74B can be an N type material. In some instances, the regions of N type material and/or P type material are formed to a concentration of 10ˆ (17-21)/cm³ at a thickness of less than 6 μm, 4 μm, 2 μm, 1 μm or 0.5 μm. The doped region can be formed by implantation or impurity diffusion techniques.

During operation of the effective length changer, a potential is applied between the electrical contacts 74. The potential causes the index of refraction of the first light transmitting medium 56 positioned between the electrical contacts 74 to change as shown by the lines labeled B. When the potential on the electrical contact 74 adjacent to the P-type material is less than the potential on the electrical contact 74 adjacent to the N-type material, a current flows through the light transmitting medium 56 and the index of refraction decreases. The reduced index of refraction decreases the effective length of the third output waveguide 88. When the potential on the index changing element adjacent to the P-type material is greater than the potential on the index changing element adjacent to the N-type material, an electrical field is formed between the index changing elements and the index of refraction increases. The increased index of refraction increases the effective length of the third output waveguide 88.

Because it is not desired to reflect the light signals out of the waveguide 62 as is the case with the switching element 18 and an attenuation based modulator 24, the change in the index of refraction can be much lower with the effective length tuner 94 than is achieved with the switching element 18 or an attenuation based modulator 24. As a result, a lower potential is typically applied between the first electrical contact 74A and the second electrical contact 74B of the effective length tuner 94.

Although the effective length tuner 94 is illustrated as being positioned on the third output waveguide 88, the same result can be achieved by positioning the effective length tuner 94 on the first output waveguide 20. Additionally, the illustrated switch 12 can effectively achieve reduction in cross talk without the modulator 24 although the modulator 24 is illustrated. Accordingly, the modulator 24 is not needed for the switch.

In some instances, a modulator 24 positioned along a first output waveguide 20 can function as an effective length tuner 94. As noted above, the switch 12 can be operated such that the primary signals are modulated but the cross talk is not. As a result, the controller 14 can provide the modulator 24 with a length control signal when the optical signals are directed toward the second output waveguide 22 and a modulation signal when the optical signals are directed toward the first output waveguide 20. The length control signal can provide the first output waveguide 20 with the effective length needed to achieve effective destruction of one or more light signals while the modulation signal can provide the primary signal with the modulation needed to extract the primary signal from the cross talk.

In the embodiments of the switching element 18 and the modulator 24 illustrated above, the second electrical contact 74B is shown adjacent to a side of a ridge 60. As an alternative to positioning the second electrical contact 74B adjacent to a side of the ridge 60, the second electrical contact 74B can be positioned under the optical component 54. For instance, the second electrical contact 74B can be positioned adjacent to the substrate 66. FIG. 13E illustrates an example of a first electrical contact 74A and the second electrical contact 74B positioned on opposing sides of the component 54.

The current or electrical field that passes between the first electrical contact 74A and the second electrical contact 74B passes through the component 54. In this embodiment, the second electrical contact 74B has a shape that mirrors the shape of the first electrical contact 74A and the second electrical contact 74B is positioned directly opposite the first electrical contact 74A on the opposing side of the optical component 54. Alternatively, the second electrical contact 74B can be shifted away from the direction that it is desired to reflect light signals.

Although many of the above illustrations show a second electrical contact 74B spaced apart from the side of a ridge 60, in some instances the second electrical contact 74B is positioned in contact with the ridge 60.

Although the controller 14 is illustrated as a single entity in many of the embodiments discussed above, the various elements of the controller 14 need not be located in the same place. For instance, the electronics 30 for modulating the light signals and extracting the modulated signal can be locally near the switching system 10 while electronics 30 for configuring and re-configuring the switch 12 are remotely located. Additionally, much of the electronics 30 can be redundant although a single element is illustrated above. For instance, a single switching system 10 can employ a plurality of signal generators 38, decoders 42, filters, etc.

Although many of the above embodiments disclose a switch 12 in the context of a switching architecture, an optical component 54 can include a single switch 12 by itself or in communication with other devices such as electro-absorption modulators, demultiplexers, etc. Additionally, an optical component 54 can include more than one switch 12 without the switches being arranged in a switching architecture. For instance, the switches need not each be arranged so as to be in communication with a common waveguide 26 or a throughput waveguide 36. Additionally, when a component 54 includes one or more switches that are not arranged in a switching architecture, the outputs of the switch(es) need not be in communication with a common waveguide 26.

Although the switch constructions illustrated above show the waveguides defined in a light transmitting medium positioned over a base, all or a portion of each waveguide can include an optical fiber. For instance, the switch can include an optical fiber acting as the input waveguide.

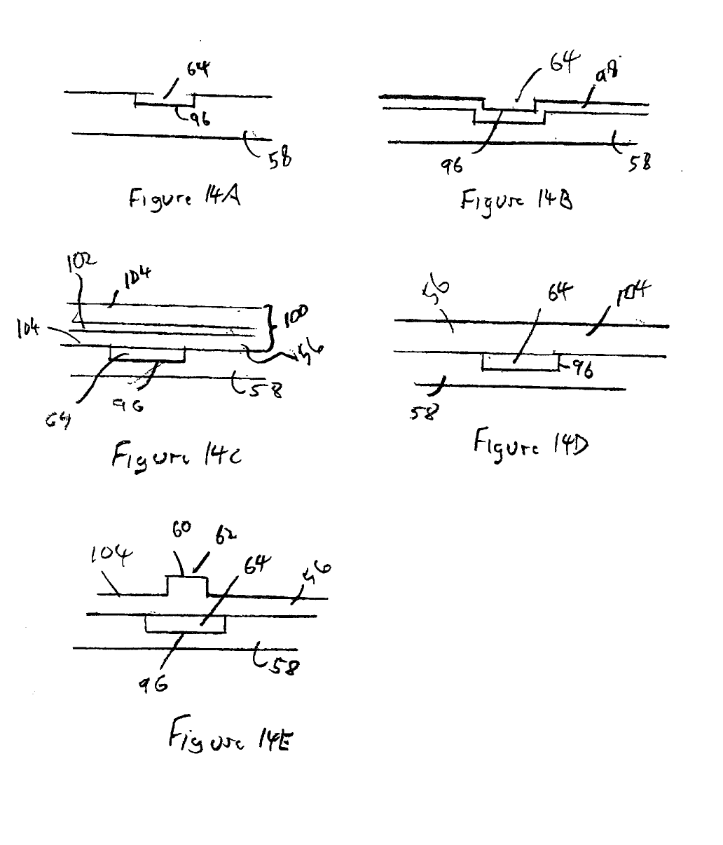

FIG. 14A to FIG. 14E illustrate a method for forming a switch having waveguides constructed as shown in FIG. 8B. A mask is formed on a base so the portions of the base where a light barrier is to be formed remain exposed. A suitable base 58 includes, but is not limited to, a silicon substrate. An etch is performed on the masked base 58 to form pockets 96 in the base 58. The pockets 96 are generally formed to the desired thickness of the light barrier 64.

Air can be left in the pockets 96 to serve as the light barrier 64. Alternatively, a light barrier material 64 such as silica or a low K material can be grown or deposited in the pockets 96. The mask is then removed to provide the component illustrated in FIG. 14A.

When air is left in the pocket 96, a second light transmitting medium 98 can optionally be deposited or grown over the base 58 as illustrated in FIG. 14B. When air will remain in the pocket 96 to serve as the light barrier, the second light transmitting medium 98 is deposited so the second light transmitting medium 98 is positioned adjacent to the sides of the light barrier 64. Alternatively, a light barrier material such as silica can optionally be deposited in the pocket 96 after the second light transmitting medium is deposited or grown.

The remainder of the method is disclosed presuming that the second light transmitting medium 98 is not deposited or grown in the pocket 96 and that air will remain in the pocket 96 to serve as the light barrier. A light transmitting medium 56 is formed over the base 58. A suitable technique for forming the light transmitting medium 56 over the base 58 includes, but is not limited to, employing wafer bonding techniques to bond the light transmitting medium 56 to the base 58. A suitable wafer for bonding to the base 58 includes, but is not limited to, a silicon wafer or a silicon on insulator wafer.

A silicon on insulator wafer 100 includes a silica layer 102 positioned between silicon layers 104 as shown in FIG. 14C. The top silicon layer 104 and the silica layer 102 can be removed to provide the component 10 shown in FIG. 14D. Suitable methods for removing the top silicon layer 104 and the silica layer 102 include, but are not limited to, etching and polishing. The bottom silicon layer 104 remains as the light transmitting medium 56 where the waveguides will be formed. A portion of the silicon layer can be removed from the top and moving toward the base in order to obtain a light transmitting medium 56 with the desired thickness.

The light transmitting medium 56 is masked such that places where a ridge is to be formed are protected. The component is then etched to a depth that provides the component with ridges 60 of the desired height as shown in FIG. 14E.

Any doped regions to be formned on the ridge, adjacent to the ridge and/or under the ridge can be formed using techniques such as impurity deposition, implantation or impurity diffusion. The electrical contacts can then be formed adjacent to the doped regions by depositing a metal layer adjacent to the doped regions.

The etch employed in the method described above can result in formation of a facet and/or in formation of the sides of a waveguide. These surfaces are preferably smooth in order to reduce optical losses. Suitable etches for forming these surfaces include, but are not limited to, reactive ion etches, the Bosch process and the methods taught in U.S. Patent application serial number (not yet assigned); filed on Oct. 16, 2000; and entitled “Formation of a Smooth Vertical Surface on an Optical Component” which is incorporated herein in its entirety.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings. As one example, those skilled in the art will recognize that the principles and advantages of the invention can be extended to cover switches having a modulator positioned on more than one output waveguide. Accordingly, many of the following claims encompass such embodiments.

1. An optical switch, comprising:
a light barrier having a surface between sides;
a first light transmitting medium having one or more ridges that each define a portion of an output waveguide, the light transmitting medium positioned such that at least one of the ridges is positioned over the surface of the light barrier; and
a second light transmitting medium positioned adjacent to the sides of the light barrier.

2. The switch of claim 1, wherein the first light transmitting medium and the second light transmitting medium are the same material.

3. The switch of claim 1, wherein the first light transmitting medium and the second light transmitting medium are silicon.

4. The switch of claim 1, wherein a width of the light barrier is larger than 150% of a width at a base of the ridge.

5. The switch of claim 1, wherein a width of the light barrier is less than 150% of a width at a base of the ridge.

6. The switch of claim 1, wherein a width of the light barrier is less than 140% of a width at a base of the ridge.

7. The switch of claim 1, wherein a width of the light barrier is less than 130% of a width at a base of the ridge.

8. The switch of claim 1, wherein a width of the light barrier is less than 120% of a width at a base of the ridge.

9. The switch of claim 1, further comprising a modulator configured to modulate light signals carried by the output waveguide.

10. The switch of claim 1, further comprising a switching element configured to direct light signals away from the output waveguide.

11. The switch of claim 1, wherein the second light transmitting medium has an index of refraction equal to or greater than an index of refraction of the first light transmitting medium.

12. The switch of claim 1, further comprising:
a first doped region positioned in the ridge and a second doped region adjacent to the ridge.

13. The switch of claim 1, further comprising:
a first electrical contact positioned over the ridge and a second electrical contact positioned adjacent to a side of the ridge.

14. The switch of claim 1, further comprising:
a first doped region positioned in the ridge and a second doped region adjacent to the ridge; and
a first electrical contact positioned over the first doped region and a second doped region positioned over the second doped region.

15. The switch of claim 1, further comprising:
a first doped region positioned in the ridge and a second doped region positioned under the ridge.

16. The switch of claim 1, further comprising:
a first electrical contact positioned over the ridge and a second electrical contact positioned under the ridge.

17. The switch of claim 1, further comprising:
a first doped region positioned in the ridge and a second doped region under the ridge; and
a first electrical contact positioned over the first doped region and a second doped region positioned over the second doped region.

18. An optical switch, comprising:
a light barrier having a surface between sides;
a first light transmitting medium having one or more ridges that each define a portion of an input waveguide, the light transmitting medium positioned such that at least one of the ridges is positioned over the surface of the light barrier; and
a second light transmitting medium positioned adjacent to the sides of the light barrier.

19. The switch of claim 18, wherein the first light transmitting medium and the second light transmitting medium are the same material.

20. The switch of claim 18, wherein a width of the light barrier is larger than 150% of a width at a base of the ridge.

21. The switch of claim 18, wherein a width of the light barrier is less than 150% of a width at a base of the ridge.

22. The switch of claim 18, wherein a width of the light barrier is less than 140% of a width at a base of the ridge.

23. The switch of claim 18, wherein a width of the light barrier is less than 130% of a width at a base of the ridge.

24. The switch of claim 18, wherein a width of the light barrier is less than 120% of a width at a base of the ridge.

25. The switch of claim 18, wherein the second light transmitting medium has an index of refraction that is greater than or equal to an index of refraction of the first light transmitting medium.

26. An optical switch comprising:
an input waveguide; and
a plurality of output waveguides in optical communication with the input waveguide, one of the output waveguides configured so as to shift a light signal from the input waveguide toward a center of another output waveguide before the light signal the other output waveguide.

27. The switch of claim 26, further comprising:
a switching element configured to direct the light signal to an output waveguide selected from among the plurality of output waveguides.

28. The switch of claim 27, wherein the switching element is not configured to direct the light signal to the output waveguide that is configured such that the light signal is centered.

29. The switch of claim 26, wherein each of the output waveguides branches off of the input waveguide at the same location along the input waveguide.

30. The switch of claim 26, wherein the plurality of output waveguides share a region of the switch and the shared region of the switch is symmetrical about an axis that is parallel to a direction of propagation of light signals traveling along the input waveguide at a location where the input waveguide meets the shared region.

31. The switch of claim 26, wherein each of the output waveguides the input waveguide are defined in a light transmitting medium positioned over a base.

32. The switch of claim 26, wherein the output waveguide that is configured such that the light signal is centered includes a terminal end angled at less than ninety degrees relative to a direction of propagation of light signals traveling along the output waveguide.

33. The switch of claim 26, wherein light signals carried in two output waveguides are combined on a common waveguide, one of the two output waveguides being the waveguide configured such that a light signal is centered.

34. The switch of claim 33, wherein the length of the two output waveguides are selected such that destructive interference occurs on the common waveguide between at least a portion of the light signals carried on each of the two output waveguides.

35. The switch of claim 34, further comprising:
an effective length tuner configured to change the effective length of an output waveguide, the effective length tuner positioned on a waveguide selected from the group consisting of the two output waveguides.

36. An optical switch comprising:
a plurality of active output waveguides;
a switching element configured to direct a light signal to an active output waveguide selected from among the plurality of active output waveguides; and
one or more secondary output waveguides configured to receive a portion of the light signal when the light signal is directed toward an active output waveguide.

37. The switch of claim 36, wherein the plurality of active output waveguides and the one or more secondary output waveguides are each in optical communication with an input waveguide.

38. The switch of claim 36, wherein each of the plurality of active output waveguides and the one or more secondary output waveguides each branch off of the input waveguide at the same location along the input waveguide.

39. The switch of claim 36, wherein the plurality of active output waveguides and the one or more secondary output waveguides share a region of the switch and the shared region of the switch is symmetrical about an axis that is parallel to a direction of propagation of light signals traveling along the input waveguide at a location where the input waveguide meets the shared region.

40. The switch of claim 36, wherein each of the active output waveguides and the secondary output waveguides are defined in a light transmitting medium positioned over a base.

41. The switch of claim 36, wherein one of the one or more secondary output waveguides has a shape that centers light signals relative to one of the active output waveguides.

42. The switch of claim 36, wherein the switching element is not configured to direct light signals to the one or more secondary output waveguides.

43. The switch of claim 36, wherein the secondary output waveguide includes a terminal end angled at less than ninety degrees relative to a direction of propagation of light signals traveling along the secondary output waveguide.

44. The switch of claim 36, wherein light signals carried in an active output waveguide and light signals carried in a secondary output waveguides are combined on a common waveguide.

45. The switch of claim 44, wherein the length of the secondary output waveguide and the active output waveguide are selected such that destructive interference results on the common waveguide between the light signals carried on the active output waveguide and the light signals carried on the secondary output waveguide.

46. The switch of claim 44, further comprising:
an effective length tuner configured to change the effective length of a waveguide, the effective length tuner positioned on a waveguide selected from a group consisting of the active output waveguide and the second output waveguide.

47. An optical switch comprising:
a plurality of active output waveguides in optical communication with an input waveguide;
one or more secondary output waveguides in optical communication with the input waveguide; and
a switching element configured to direct light signals to an output waveguide that is selectable from among only the active output waveguides.

48. The switch of claim 47, wherein each of the plurality of active output waveguides and the one or more secondary output waveguides each branch off of the input waveguide at the same location along the input waveguide.

49. The switch of claim 47, wherein the plurality of active output waveguides and the one or more secondary output waveguides share a region of the switch and the shared region of the switch is symmetrical about an axis that is parallel to a direction of propagation of light signals traveling along the input waveguide at a location where the input waveguide meets the shared region.

50. The switch of claim 47, wherein one of the one or more secondary output waveguides has a shape that centers light signals relative to one of the active output waveguides.

51. The switch of claim 47, wherein the secondary output waveguide includes a terminal end angled at less than ninety degrees relative to a direction of propagation of light signals traveling along the secondary output waveguide.

52. The switch of claim 47, wherein light signals carried in an active output waveguide and light signals carried in a secondary output waveguides are combined on a common waveguide.

53. An optical switch, comprising:
a first output waveguide in optical communication with an input waveguide
a second output waveguide in optical communication with the input waveguide;
a switching member configured to direct light signals to the first output waveguide or the second output waveguide; and
a third output waveguide in optical communication with the input waveguide, the third output waveguide configured to receive a portion of each light signal directed to the second output waveguide.

54. The switch of claim 53, wherein the third output waveguide is configured such that the light signals are centered relative to the second output waveguide.

55. The switch of claim 53, wherein each of the output waveguides branch off of the input waveguide at the same location along the input waveguide.

56. The switch of claim 53, wherein each of the output waveguides share a region of the switch and the shared region is symmetrical about an axis that is parallel to a direction of propagation of light signals traveling along the input waveguide at the location where the input waveguide meets the shared region.

57. The switch of claim 53, wherein the switching element is not configured to direct light signals to the third output waveguide.

58. The switch of claim 53, wherein the third output waveguide includes a terminal end angled at less than ninety degrees relative to a direction of propagation of light signals traveling along the third output waveguide.

59. The switch of claim 53, wherein light signals carried in the first output waveguide and the second output waveguide are combined on a common waveguide.

60. The switch of claim 59, wherein the length of the first output waveguide and the length of the second output waveguide are selected such that destructive interference results on the common waveguide between the light signals carried on the first output waveguide and the light signals carried on the second output waveguide.

61. The switch of claim 59, further comprising:
an effective length tuner configured to change the effective length of a waveguide, the effective length tuner positioned on a waveguide selected from a group consisting of the first output waveguide and the second output waveguide.

62. An optical switch, comprising:
a plurality of output waveguides in optical communication with one or more input waveguides; and
a modulator configured to modulate light signals being carried by a first output waveguide, the first output waveguide being one of the plurality of output waveguides.

63. The switch of claim 62, wherein the one or more input waveguides and the one or more output waveguides are formed in a light transmitting medium positioned over a base.

64. The switch of claim 62, wherein one or more of the plurality of output waveguides is in optical communication with a common waveguide, the common waveguide being in optical communication with other optical switches.

65. The switch of claim 64, wherein two output waveguides are in optical communication with the common waveguide.

66. The switch of claim 64, wherein the first output waveguide is in optical communication with the common waveguide.

67. The switch of claim 62, further comprising:
a light sensor configured to convert the light signals carried by the first output waveguide into electrical signals.

68. The switch of claim 67, further comprising:
electronics for separating a modulated portion of the electrical signals from a remainder of the electrical signals, the modulated portion resulting from operation of the modulator.

69. The switch of claim 62, further comprising:
a switching element configured to direct the light signal from an input waveguide to one of the output waveguides.

70. The switch of claim 62, wherein the switch includes three output waveguides.

71. The switch of claim 70, further comprising:
an effective length tuner configured to change the effective length of one of the three output waveguides.

72. The switch of claim 70, wherein the intersection of the three output waveguide is symmetrical about a longitudinal axis of a center waveguide of the three output waveguides.

73. An optical switch, comprising:
a switching element configured to direct light signals to at least one of a plurality of output waveguides; and
a modulator configured to modulated light signals carried by a first output waveguide, the first output waveguide being one of the plurality of output waveguides.

74. The switch of claim 73, wherein one or more of the plurality of output waveguides is in optical communication with a common waveguide, the common waveguide being in optical communication with other optical switches.

75. The switch of claim 74, wherein two output waveguides are in optical communication with the common waveguide.

76. The switch of claim 74, wherein the first output waveguide is in optical communication with the common waveguide.

77. The switch of claim 73, further comprising:
a light sensor configured to convert the light signals carried by the first output waveguide into electrical signals.

78. The switch of claim 77, further comprising:
electronics for separating a modulated portion of the electrical signals from a remainder of the electrical signals, the modulated portion of the electrical signals resulting from operation of the modulator.

79. An optical switching architecture, comprising:
a plurality of optical switches, each optical switch having a plurality of output waveguides;
a common waveguide in optical communication with a first output waveguide from each of the optical switches; and
a plurality of modulators, each modulator configured to modulate the light signals carried by one of the first output waveguides.

80. The switching architecture of claim 79, wherein each switch includes two output waveguides in optical communication with the common waveguide.

81. The switching architecture of claim 79, further comprising:
a light sensor configured to convert the light signals carried by the common waveguide into electrical signals.

82. The switching architecture of claim 81, further comprising:
electronics for separating an modulated portion of the electrical signals from a remainder of the electrical signals, the modulated portion of the electrical signals resulting from operating one or more of the modulators.

83. The switching architecture of claim 81, further comprising:
electronics for separating a modulated portion of the electrical signals from the remainder of the electrical signals, the modulated portion of the electrical signals resulting from operating a particular one of the modulators.

84. The switching architecture of claim 79, wherein each switch includes three output waveguides.

85. The switching architecture of claim 79, wherein two of the three output waveguides are in optical communication with the common waveguide.

86. A method for operating a switch, comprising:
directing light signals toward at least one of a plurality of output waveguides; and
modulating light signals carried on a first output waveguide, the first output waveguide being one of the plurality of output waveguides.

87. The method of claim 86, further comprising:
operating the modulator when light signals are directed toward the first output waveguide and not operating the modulator when the light signals are directed toward an output waveguide other than the first output waveguide.

88. The method of claim 86, further comprising:
operating the modulator when the light signals are directed toward an output waveguide other than the first output waveguide and not operating the modulator when light signals are directed toward the first output waveguide.

89. The method of claim 86, further comprising:
operating the modulator with a first modulation signals when light signals are directed toward the first output waveguide and operating with a second modulation signals when the light signals are directed toward an output waveguide other than the first output waveguide.

90. The method of claim 86, further comprising:
receiving the light signals carried on the first output waveguide on a common waveguide, the common waveguide being in optical communication with other optical switches.

91. The method of claim 86, further comprising:
receiving the light signals carried on the first output waveguide at a light sensor configured to convert the light signals to electrical signals.

92. The method of claim 91, further comprising:
separating a modulated portion of the electrical signals from an unmodulated portion of the electrical signals, the modulated portion of the electrical signals resulting from modulation of the electrical signals carried on the first output waveguide.

93. The method of claim 92, further comprising:
processing the modulated portion of the electrical signal independent of the unmodulated portion of the electrical signal.

94. The method of claim 92, further comprising:
processing the unmodulated portion of the electrical signal independent of the modulated portion of the electrical signal.

95. The method of claim 91, further comprising:
separating a modulated portion of the electrical signals from the remainder of the electrical signals, the separated portion of the electrical signals resulting from operation of the switch.

96. The method of claim 86, wherein modulating the electrical signals includes encoding the light signals carried on the first output waveguide.

97. The method of claim 96, further comprising:
converting the encoded light signals to electrical signals; and
decoding an encoded portion of the electrical signals, the encoded portion of the electrical signals resulting from converting the encoded portion of the light signals to electrical signals.

98. A method of operating a switch, comprising:
converting light signals carried on a common waveguide to electrical signals, the common waveguide receiving the light signals from a plurality of optical switches; and
separating a modulated portion of the electrical signals from the remainder of the electrical signals, the modulated portion of the electrical signals resulting from the light signals from one or more of the optical switches being modulated before entering the common waveguide.

99. The method of claim 98, wherein separating the modulated portion of the electrical signals includes separating the portion of the electrical signals that result from modulation the light signals from a particular one of the optical switches.
